(19) United States
(12) Patent Application Publication
(10) Pub. No.: US 2008/0062451 A1
(43) Pub. Date: Mar. 13, 2008

(54) Copy Machine with Copy Control Function, Scanner and Facsimile, and Piece of Paper and Film each Installed with Semiconductor Device

(75) Inventor: Shunpei Yamazaki, Tokyo (JP)

Correspondence Address: ERIC ROBINSON, PMB 955, 21010 SOUTHBANK ST., POTOMAC FALLS, VA, 20165, US

(73) Assignee: SEMICONDUCTOR ENERGY, KANAGAWA-KEN JAPAN (JP)

(21) Appl. No.: 11/596,807

(22) PCT Filed: Jun. 8, 2005
(86) PCT No.: PCT/JP05/10908

§ 371 Date: Nov. 17, 2006

(30) Foreign Application Priority Data
Jun. 14, 2004 (JP) 2004-176197

(51) Int. Cl. G03G 21/04

(52) U.S. Cl. 358/1.14; 358/468; 358/474

(57) ABSTRACT

According to one feature of the invention, a device provided with a mechanism for performing copying, replicating, scanning, transmitting, or the like of a manuscript comprises a semiconductor device mounted on the manuscript and a reader capable of communicating; and a control portion for controlling whether copying, replicating, scanning, transmitting, or the like of the manuscript can be performed or not based on information obtained from the reader. Accordingly, an illicit act such as an illicit copy can be prevented by determining and/or controlling whether a manuscript can be copied or not.

### TECHNICAL FIELD

The present invention relates to a copy machine, a scanner, and a facsimile capable of controlling whether manuscripts, documents, books, bills, or the like is reproduced and sent or not. Further, the invention relates to a piece of paper and a film each installed with a semiconductor device capable of controlling whether copying can be performed or not by using the copy machine or the like.

### BACKGROUND ART

In recent years, a document, a book, or the like is reproduced and copied daily in every company, home, store, or the like. However, in many cases, the document, the book, or the like includes confidential information such as trade secret or personal information, and it is strongly required to strengthen the management system of the information especially in economic activities and trade activities. However, such confidential information remains to be able to be copied easily using a coping machine, a scanner, or the like within a company, a home, or the like, which results in an illicit act such as leakage or falsification of confidential information. In order to solve such a problem, a copy machine with a procedure using a barcode for preventing counterfeit is known (see Reference 1: Japanese Patent Application Laid-Open No. 2001-51460).

### DISCLOSURE OF INVENTION

However, a barcode itself tends to be doctored and thus there is a fear that the barcode does not fulfill a function for preventing a reproduction and a counterfeit of a document or the like even when this procedure of using barcode is performed. In the case of a plurality of sheets of a document, since whether there is the possibility of a reproduction or not needs to be determined by reading a barcode per sheet, there is a problem that the throughput delays. Although it can assume that a barcode is attached to general documents, it is difficult to assume that a barcode is also attached to bills, valuable stock certificates, goods of design-conscious cards, or the like. However, when a copy machine having extremely high-performance is marketed in future, there is a fear that bill, valuable stock certificates, or the like can be reproduced effortlessly.

In view of the foregoing problem, it is an object of the invention to provide a copy machine capable of preventing a copy and a reproduction of books, documents, bills, or the like. Further, the act of copying and reproducing is a cause of resulting in leakage of confidential information and flow of a counterfeit product. Therefore, the invention prevents the foregoing illicit act from occurring by excluding such an act of copying and reproducing; thus, it is an ultimate object of the invention to be of some help of sound economic activities and trade activities.

According to one feature of the invention, a device provided with a mechanism for performing copying, reproducing, scanning, transmitting, or the like of a manuscript comprises a semiconductor device mounted on the manuscript and a reader capable of communicating; and a control portion for controlling whether copying, reproducing, scanning, transmitting, or the like of the manuscript can be performed or not based on information obtained from the reader.

Specifically, according to another feature of the invention, a copy machine with a copy control function comprises a semiconductor device mounted on a manuscript and a reader capable of communicating; a control portion for controlling whether the manuscript can be copied or not based on information obtained from the reader; and an optical system and a print unit for copying the manuscript.

According to another feature of the invention, a copy machine with a copy control function comprises a semiconductor device mounted on a manuscript and a reader capable of communicating; a control portion for controlling whether the manuscript can be copied or not based on information obtained from the reader; and an optical system, a light-receiving element, an image processing portion, a laser scanner, and a print unit for copying the manuscript.

Here, a copy machine refers to a device having a function to read a manuscript, a document, a photograph, or the like and to copy it into another medium (such as a variety of paper or a film).

In addition, a copy machine according to the invention comprises a semiconductor device mounted on a manuscript and a reader capable of communicating, and a control portion for controlling whether the manuscript can be copied or not based on information obtained from the reader. Then, the reader may combine a function to write information into the semiconductor device mounted on the manuscript or a semiconductor device mounted on a copy material.

Further, the foregoing manuscript includes not only a document, a newspaper, a magazine, and a photograph but also widely includes one like books and OHP films, bills, valuable stock certificates, and the like.

According to another feature of the invention, a scanner with a scan control function comprises a semiconductor device mounted on a manuscript and a reader capable of communicating; a control portion for controlling whether the manuscript can be scanned or not based on information obtained from the reader; and an optical system, a light-receiving element, and an image processing portion for scanning the manuscript.

Here, the reader may combine a function to write information into the semiconductor device mounted on the manuscript.

According to another feature of the invention, a facsimile with a read control function comprises a semiconductor device mounted on a manuscript and a reader capable of communicating; a control portion for controlling whether the manuscript can be read or not based on information obtained from the reader; and an optical system, a light-receiving element, and an image processing portion for reading the manuscript, and a communication control portion for transmitting information which is read.

Here, the reader may combine a function to write information into the semiconductor device mounted on the manuscript.

According to another feature of the invention, a piece of paper and a film each installed with a semiconductor device can control whether copying can be performed or not by the copy machine with a copy control function, the scanner with scan control function, or the facsimile with a read control function

Here, the case capable of controlling whether copying can be performed or not includes any one of the case where a piece of paper and a film each installed with a semiconductor device are used as a manuscript and where the piece of paper and the film are used as a medium of a copy material.

Further, the material of the piece of paper and the film referred here is not limited particularly as long as a semiconductor device is mounted. An ID chip, a radio chip, a radio memory, and the like are given as an example of the semiconductor device.

In addition, the semiconductor device mounted on the manuscript stores decision of whether copying, scanning, reading, or the like of the manuscript can be performed or not, and information thereon. It is desirable for the semiconductor device to include, for example, a thin film active element like a thin film transistor (hereinafter referred to as “TFT”). For example, when the semiconductor device is manufactured using a TFT, a TFT is formed over the substrate to be peeled and then the substrate is peeled to separate elements from each other; therefore, the semiconductor device including a TFT can be mass-produced inexpensively. The peeling method referred here is classified roughly into chemical peeling that removes a peeling layer by etching or the like and physical peeling that separates a peeling layer by applying external stress; however, the peeling method is not limited thereto.

Note that a semiconductor device according to the invention differs from a conventional IC chip and includes a structure of a thin film. For example, since the conventional IC chip is approximately 60 μm thick, the semiconductor device includes a thinner chip. In the case of a thin film semiconductor device, it is also referred to as an IDT chip (Identification Thin Chip). As to be described later, a semiconductor device according to the invention is generally formed without using a silicon wafer but formed using an insulating substrate such as a glass substrate or a quartz substrate. In addition, since an ID chip can be transferred to a flexible substrate, it is also referred to as an IDG chip (Identification Glass Chip), an IDF chip (Identification Flexible Chip), a soft chip, and the like.

Here, information obtained from the reader is not limited to information stored in the semiconductor device of the manuscript. The information may be information which shows that communication cannot be made between the reader and the manuscript when a semiconductor device is attached to the manuscript or not, or when the semiconductor device mounted on the manuscript does not function due to breakdown or the like.

Accordingly, when communication cannot be obtained between a reader and a manuscript for example, copying, scanning, reading, or the like of the manuscript can be rejected by a control portion. Note that copying or the like may be permitted by the control portion.

A copy machine with a copy control function according to the invention is equipped with a semiconductor device mounted on a manuscript and a reader capable of communicating; a control portion for controlling whether the manuscript can be copied or not based on information obtained from the reader; and at least an optical system and a print unit for copying the manuscript. Therefore, whether a manuscript can be copied or not can be controlled and thus an unauthorized copy and an unnecessary copy can be prevented.

In addition, a scanner with a scan control function according to the invention is equipped with a semiconductor device mounted on a manuscript and a reader capable of communicating; a control portion for controlling whether the manuscript can be scanned or not based on information obtained from the reader; and an optical system, a light-receiving element, and an image processing portion for scanning the manuscript. Therefore, whether a manuscript can be scanned or copied can be controlled and thus an unauthorized copy and an unnecessary copy can be prevented.

Further, a facsimile with a read control (that is, transmission control) function according to the invention is equipped with a semiconductor device mounted on a manuscript and a reader capable of communicating; a control portion for controlling whether the manuscript can be read or not based on information obtained from the reader; and an optical system, a light-receiving element, and an image processing portion for reading the manuscript, and a communication control portion for transmitting information which is read. Therefore, whether scanning and copying of a manuscript can be controlled and thus unauthorized and unnecessary flow of information can be prevented.

Each device according to the invention can prevent a manuscript such as books, documents, and bills from being copied, duplicated, and sent illicitly with the advantageous effect of the foregoing operation. Therefore, an illicit act such as leakage of confidential information or flow or the like of counterfeit bills and goods can be rooted out.

A thin film integrated circuit portion formed of a thin film active element like a TFT is used as a semiconductor device mounted on a piece of paper or a film capable of controlling whether copying can be performed or not by each of the foregoing devices. In this case, since the semiconductor device can be mass-produced at low cost, the piece of paper or the film each installed with a semiconductor device can be used economically for a manuscript or a piece of copy paper.

In other words, after forming TFTs over a substrate to be peeled, the thin film integrated circuit portion can be manufactured by a method for peeling a substrate, a method for separating elements from each other, or the like. Consequently, the semiconductor device can be mass-produced at low cost. Specifically, there is no need to polish the backside (back grinding) as in the case of the conventional IC chip formed over a silicon substrate, and the steps can be simplified widely and the manufacturing cost can be reduced sharply. Since a substrate less expensive than a silicon substrate such as a glass substrate, a quartz substrate, or a solar battery silicon substrate (solar battery grade silicon substrate) can be used for the substrate to be peeled and further the substrate to be peeled can be reused, the cost can be reduced sharply. Further, there is no need to perform back grinding that cause a clack or a trail of polishing as in the case of the IC manufactured using a silicon wafer. In addition, variation of an element in thickness depends on variation at the time of forming each film including the IC; therefore, the variation is several hundred nm at most, which can be suppressed extremely smaller compared with variation of several μm to several ten μm due to back grinding.

In addition, since a semiconductor device is formed of a thin film active element, a piece of paper that is a manuscript or copy paper, a film, or the like can easily contain the semiconductor device, or the semiconductor can be mounted thereon easily.

### BRIEF DESCRIPTION OF DRAWINGS

In the accompanying drawings:

FIGS. 1A and 1B illustrate a perspective view of a copy machine according to one aspect of the present invention;

FIGS. 2A and 2B illustrate a block diagram of a structure of a copy machine according to one aspect of the present invention;

FIG. 3 illustrates a flow diagram of an operation of an analog copy machine according to one aspect of the present invention;

FIG. 4 illustrates a flow diagram of an operation of a digital copy machine according to one aspect of the present invention;

FIGS. 5A and 5B illustrate a perspective view and a block diagram of the structure of a scanner according to one aspect of the present invention;

FIGS. 6A and 6B illustrate a perspective view and a block diagram of the structure of a facsimile according to one aspect of the present invention;

FIGS. 7A to 7O illustrate a view of a manufacturing step (step of separating an element in FIGS. 7J to 7O) of an ID chip mounted on a manuscript or the like according to one aspect of the present invention;

FIGS. 8A and 8B illustrate a view of a manufacturing step (sealing step) of an ID chip mounted on a manuscript or the like according to one aspect of the present invention;

FIGS. 9A to 9C illustrate a view of a method for attaching a thin film integrated circuit portion to an inlet substrate;

FIGS. 10A to 10C illustrate a view of a method for attaching an ID chip to a raw material such as manuscript;

FIG. 11 illustrates an explanatory view of a communication principle between an ID chip and an R/W; and

FIG. 12 illustrates a flow diagram of an operation (writing into a semiconductor device) of a copy machine according to one aspect of the present invention.

### BEST MODE FOR CARRYING OUT THE INVENTION

Embodiment Modes of the present invention will be described below with reference to the accompanying drawings. However, various modes will be applicable to the invention and the mode and the detail of the invention can be variously changed without departing from the purpose and the scope of the invention. For example, the invention can be implemented by appropriately combining each of these embodiment modes and embodiments and common technical knowledge during the implementation. Therefore, the invention is not interpreted with limitation to the description of these embodiment modes.

### Embodiment Mode 1

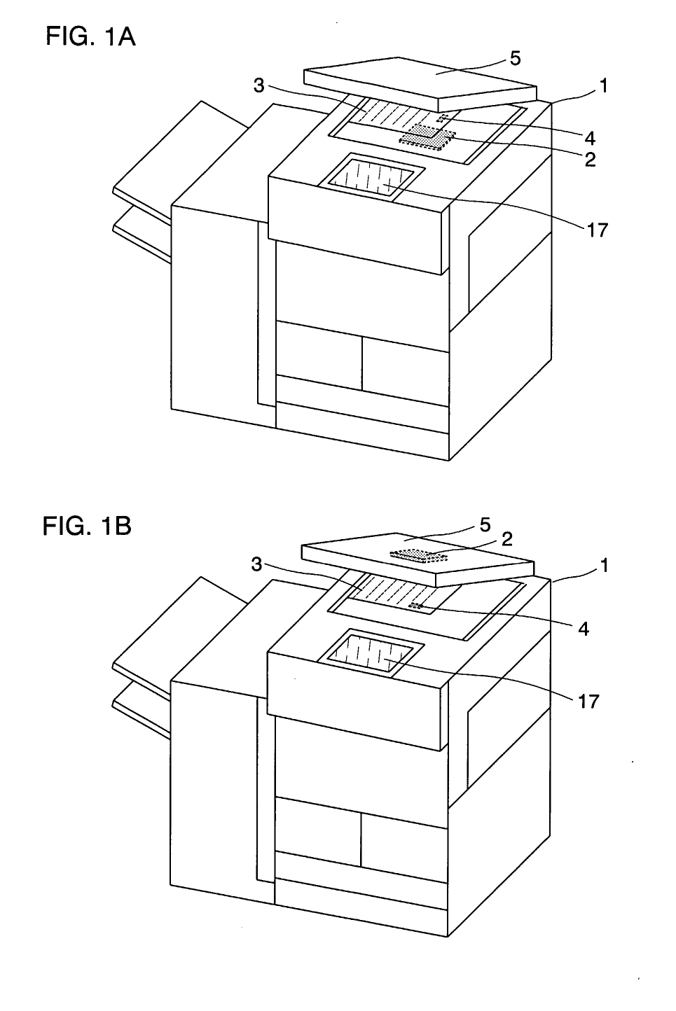

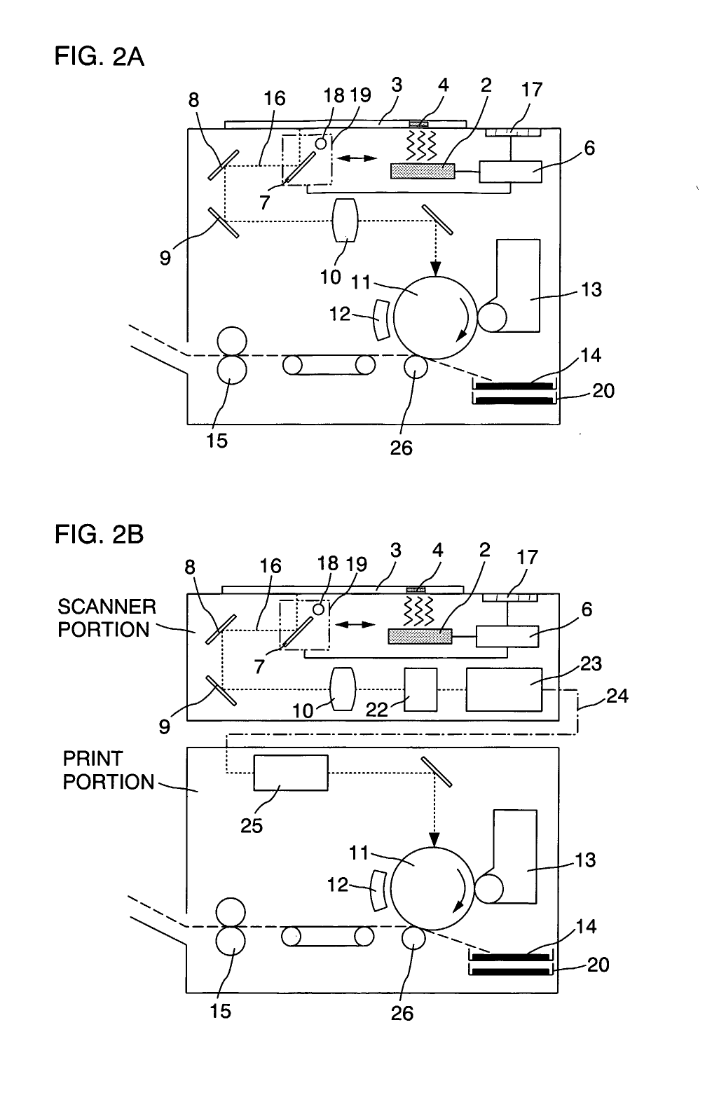

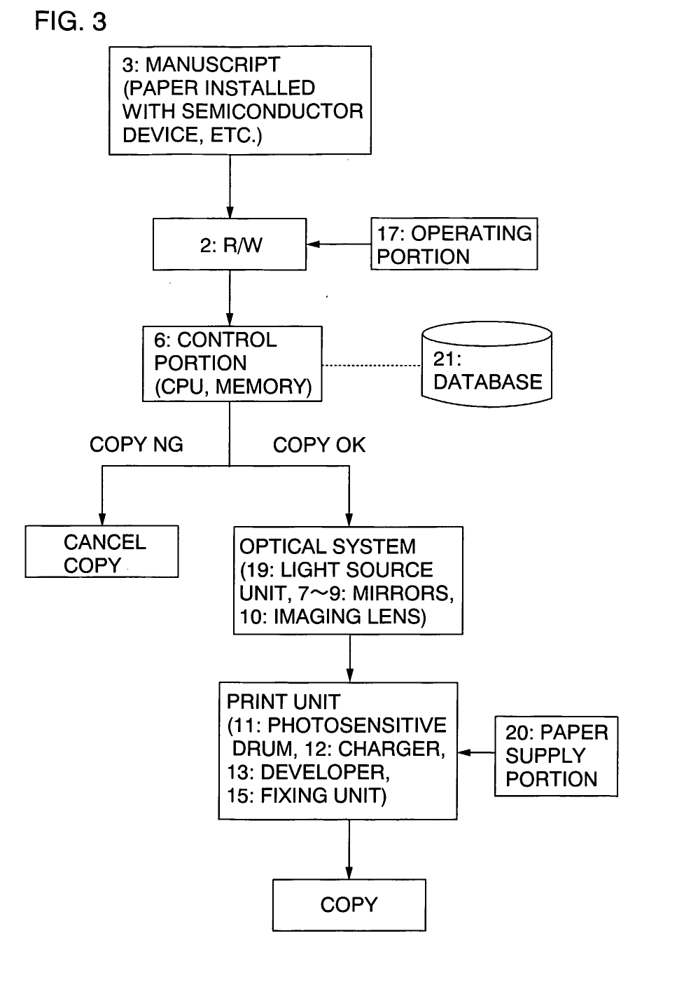

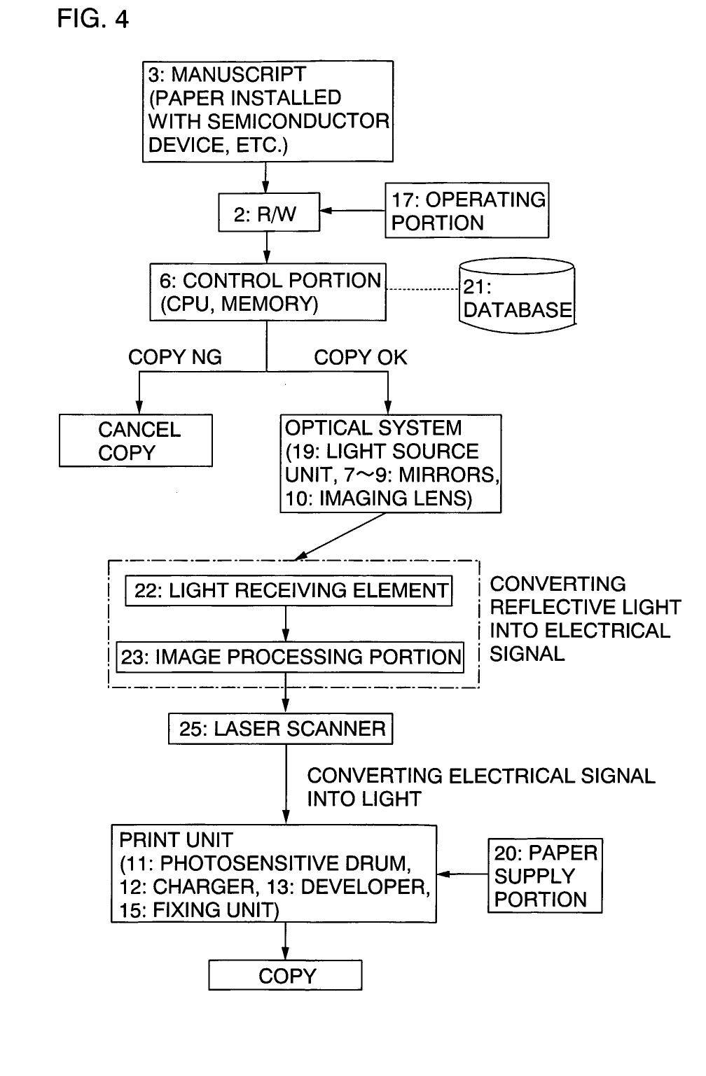

This embodiment mode describes a copy machine according to the present invention with reference to FIGS. 1A and 1B, FIGS. 2A and 2B, FIG. 3, and FIG. 4. FIGS. 1A and 1B are each perspective views of a copy machine according to the invention. FIGS. 2A and 2B are each block diagrams illustrating a structure of an analog and a digital copy machine according to the invention. FIG. 3 and FIG. 4 are each a flow diagram illustrating control of whether copying is performed or not and a flow diagram illustrating a flow of copying, in an analog and a digital copy machine according to the invention. FIG. 3 and FIG. 4 are each, in an analog and a digital copy machine according to the invention, a flow diagram illustrating control of whether copying is performed or not and a flow diagram illustrating a flow of copying.

As illustrated in FIGS. 1A and 1B and FIGS. 2A and 2B, a copy machine 1 is installed therein with a reader/writer 2 (hereinafter also referred to as “R/W”) for reading information on a semiconductor device 4 mounted on a manuscript 3. The R/W 2 is connected to a control portion 6 for controlling a copy mechanism.

The control portion 6 includes at least a CPU and a memory including ROM, RAM, nonvolatile memory, and the like (see FIG. 3 and FIG. 4), and has operations each for distinguishing whether the manuscript 3 can be copied or not and for controlling the copy based on information on the semiconductor device 4 obtained by the R/W 2. If required, a database 21 may be connected to the control portion 6 (see FIG. 3 and FIG. 4). Note that the control portion 6 and the database 21 may be provided in the interior of the copy machine 1 or in a cover 5 for covering the manuscript 3 or may be externally connected by a fixed-line or a wireless network.

In addition, the control portion 6 is connected to at least a light source unit 19 for irradiating the manuscript 3 with light. Consequently, whether the manuscript 3 is copied or not is controlled by controlling whether the manuscript 3 is irradiated with light or not (see FIG. 3 and FIG. 4).

The manuscript 3 is not limited to a manuscript (such as a piece of paper installed with a semiconductor device) made of a variety of paper as long as the semiconductor device 4 is mounted thereon. For example, the manuscript 3 may be photographs, special films such as OHP sheets, bills, valuable stock certificates, or the like.

In addition, the semiconductor device 4 has a characteristic of a non-contact type and includes an antenna wound in a coil shape or a loop shape. The intensity of a frequency to be received can be chosen by controlling the winding number of this antenna. For example, the winding number of the antenna can be made small by intensifying the frequency and shortening the wavelength.

The R/W 2 is not limited to a structure in which the R/W 2 is provided in the same space where an optical system or a print unit is provided (see FIG. 3). As in FIG. 1B, the R/W 2 may be provided in the interior of the cover 5 for covering the manuscript 3 of the copy machine 1. Besides, there is no limitation on a place to provide the R/W 2 as long as the place is capable of communicating with the semiconductor device 4 mounted on the manuscript 3. If required, the R/W 2 may be provided in a plurality of places.

Here, the following method is typically used for communication between the R/W 2 and the semiconductor device 4: an electromagnetic inducing type for utilizing induced electromotive force (a communication distance of approximately 1 m or less), an electromagnetic coupling type for utilizing mutual induction of a coil due to an alternating current magnetic field or an electrostatic coupling type utilizing induction effect due to static electricity (each communication distance of approximately several mm to several ten mm), a microwave type for sending and receiving data due to a microwave (2.45 GHz), or an optical communication type for updating an ID label by utilizing space electrical transmission by light due to near-infrared ray (a communication distance of approximately several ten cm).

There is no particular limitation on a method of communication between the R/W 2 and the semiconductor device 4. The position of the semiconductor device 4 mounted on the manuscript 3 is not necessarily the same depending on a manufacturing method of a piece of paper installed with a semiconductor device or the like used as the manuscript 3. Therefore, an electromagnetic wave or the like generated from the R/W 2 is desirably designed to spread over the manuscript 3.

In general, in the case of copying and sending a facsimile, copying or the like of a manuscript is not necessarily performed per sheet and a plurality of sheets of a manuscript is copied at a time in many cases. In such a case, when the plurality of sheets of the manuscript includes at least one sheet which is forbidden copying, the distance until an electromagnetic wave or the like which is generated from the R/W 2 reaches is preferably set so that copying or the like can be forbidden. In addition, a function for notifying in which page the manuscript that is forbidden copying or the like exists may also be provided.

Since the R/W 2 has a function for reading information on the semiconductor device 4, it is enough if the R/W 2 has at least a reading function. However, the R/W 2 not only read information on the semiconductor device 4 but also newly gives some information to the semiconductor device mounted on the manuscript 3; therefore, the R/W 2 desirably has a writing function.

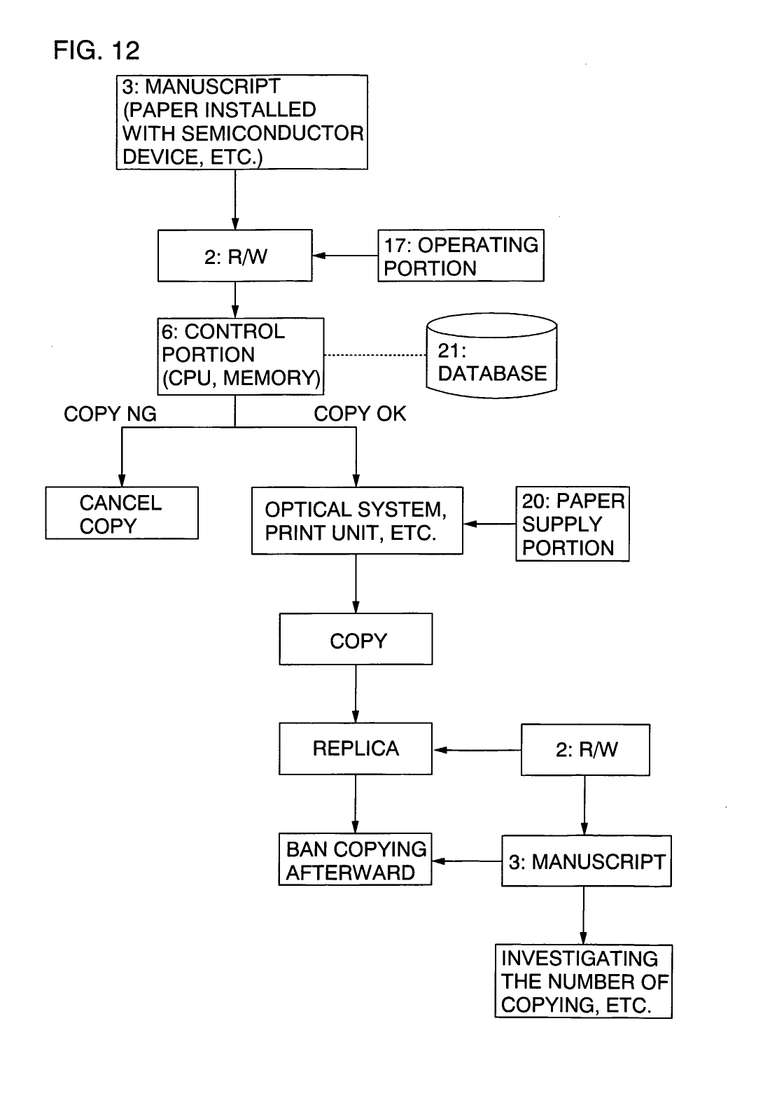

For example, in the case where the number of times of copying is limited according to the nature of the manuscript 3 (for example, the case where copying just once is permitted), such information that forbids the following copies can be written in the semiconductor device 4 at a first copy. In addition, also in the case where the number of times of copying is not particularly restricted, the user can write in the semiconductor device 4 information that forbids the following copies at any time, when the following copies is arbitrarily desired to be forbidden (see FIG. 12).

In the case where a semiconductor device is mounted on a copy material that is newly made due to copying, information is inputted into the semiconductor device from the R/W 2; therefore, further copying of the copy material can be forbidden appropriately (see FIG. 12).

In other words, since there is a writing function in the R/W 2, any information can be given to the semiconductor device mounted on the manuscript 3, which is a material to be copied and to a new copy material.

Accordingly, it is enough for the R/W 2 in the copy machine according to the invention to have at least a reading function (receiving function); however, if the R/W 2 has a writing function (sending function), it is significant in enhancing usage and convenience of the copy machine 1 according to the invention. Note that, hereinafter in this specification, the “R/W 2” includes not only in the case where a reading function and a writing function are combined but also in the case where only a reading function is provided.

In this case, not only information that determines whether copying can be performed or not which is compared with information on the semiconductor device 4 but also information that restricts the following copying or the like (in other words, new information to be written in) may be stored in the foregoing database 21.

Here, the copy machine 1 is to make a copy of the manuscript 3 such as a manuscript or part of a book, which can be copied by enlargement or microcopy and the size of the paper is variable, too. In addition, the copy machine 1 may be either a dry type or a wet type. The copy machine 1 may be capable of a color copy. Although a piece of plain paper (copy paper) is usually used as copy paper 14 for transferring the content of the manuscript 3, the content may be printed on a special film such as an OHP sheet, and the kind, the material, the size, and the like are not limited. Further, the copy machine 1 is usually equipped with a paper holder for stocking a large amount of paper and a manual paper tray for temporarily inserting a piece of special paper. Furthermore, even when the copy machine 1 is connected to a network to be a compound machine of various functions such as a copy, a facsimile, a scanner, or the like, the copy machine 1 corresponds to a copy machine according to the invention as long as the copy machine 1 is a machine including at least a mechanism as copy machine.

The following can be given as an example of a kind of a copy machine: a silver-salt type (a diffusion transfer type, a pigment transfer type, and a stabilization type), a diazo type, a thermography type, a dual spectrum type, an electrophotography type (xerography, dry electrofacsimile, and wet electrofacsimile), and the like.

In addition, either an analog copy machine or a digital copy machine may be used as the copy machine.

In the case of the analog copy machine, its structure is briefly described with reference to FIG. 2A. The structure of the analog copy machine includes at least a light source unit 19 (including at least a light source 18 and a first mirror 7, which hereinafter the same) for scanning a manuscript 3 by the light source 18, an optical system (including at least the light source unit 19, second and third mirrors 8 and 9, and an imaging lens 10, which hereinafter the same), a print unit (including at least a charger 12, a photosensitive drum 11, a developer 13, and a fixing unit 15, which hereinafter the same), a paper supply portion 20 for supplying a piece of copy paper 14, and an operating portion 17. The operating portion 17 is connected to an R/W 2 or a control portion 6. Note that the number of mirrors is not limited to the foregoing number.

Further, a feature of the copy machine 1 according to the invention is that the copy machine 1 is equipped with at least the foregoing R/W 2 and the control portion 6 in addition to the foregoing structure.

Here, a fluorescent lamp, a halogen lamp, or the like is used as a light source for lighting (lamp) of a manuscript 3. Then, the manuscript 3 is lighted in a slit shape by using the light source for lighting (not shown) and the first mirror 7 is scanned to image reflective light 16 to the photosensitive drum 11 that is a photoreceptor by interposing the second and the third mirrors 8 and 9 and the imaging lens 10 therebetween.

The photosensitive drum 11 is also a core of a device for forming an image and has a structure in which a photoconductive thin film is formed on a surface of a metal cylinder. By utilizing the difference of electrical resistance generated at the time of light and dark of this photoconductive thin film, an image proportionate to an exposed image of the manuscript is formed. A thin film having Se, CdS, a-Si, OPC (organic semiconductor), or the like is used as the photoconductive thin film of the photosensitive drum.

Here, a copy process in a xerography type among the foregoing types of a copy machine is described with reference to FIGS. 2A and 2B.

First, the photosensitive drum 11 is charged to give photosensitivity. The charge is performed at a dark place and ion is generated by the charger 12 (for example, a corona discharge generator) connected to a high voltage source to give an electric charge evenly to a photoconductive layer of the photosensitive drum 11.

Then, electrostatic latent image is formed by exposing the photosensitive drum 11 to light. Generally, the electrostatic latent image is formed by exposing the photosensitive drum 11 charged by projection light-exposure to light and by partially discharging light by photoconductivity of the photoconductive layer. The electric charge decreases at a portion irradiated with light and the electric charge remains at a portion not irradiated with light. Accordingly, the electrostatic latent image is formed. In the case of an analog copy machine, a halogen lamp is mainly used as light source of light exposure.

The electrostatic latent image is developed with a toner by the developer 13. The electrostatic latent image is developed by electrically absorbing the toner in the electrostatic latent image of the photosensitive drum 11. The toner is usually charged to a polarity reverse to the electrostatic latent image to be absorbed easily, and the toner in physical contact with a photoreceptor to be absorbed easily is used.

An image of the toner that is developed over the photosensitive drum 11 is transferred to the copy paper 14. Transfer is performed electrically, and the photoreceptor absorbed with the toner is overlapped with the copy paper 14. After charging an electric charge of which polarity is as the same as that of the latent image to a piece of paper, the copy paper 14 is peeled off from the photosensitive drum. Accordingly, the toner is absorbed in the copy paper 14 and transferred thereto.

Heat is applied to an image transferred by a transfer unit 26 to adhere to the image of the toner. The image of the toner adheres by heating the image of the toner after transfer and by dissolving resin at a circumference of the toner to weld to the copy paper 14. An oven type using a halogen heater, a heating roller type, a flash lamp type, and the like are given as an example of a heating method.

After transfer, the photosensitive drum 11 is cleaned for the next copy. This is because the toner left in the photosensitive drum 11 results in deteriorating image quality at the time of the next copy. Specifically, after transfer, the toner is physically removed by a brush or the like after removing electricity of the photoreceptor by using a cold cathode fluorescent lamp, a filament lamp, or a light-emitting diode (LED) so that the remaining toner is removed easily.

Sequentially, the case of a digital copy machine is described. FIG. 2B illustrates a cross-sectional structure of the digital copy machine, and FIG. 4 illustrates a block diagram of the structure. As illustrated in FIG. 2B, the digital copy machine is roughly constituted of a scanner portion and a print portion. The scanner portion is equipped with at least a light receiving element 22 and an image processing portion 23 in addition to an optical system (a light source unit 19, mirrors 7 to 9, and an imaging lens 10). The light receiving element 22 and the image processing portion 23 each convert reflective light 16 from a manuscript 3 into an electrical signal 24.

Here, reading of the manuscript 3 at the scanner portion is described. An image of a manuscript such as a piece of paper installed with a semiconductor device which is the manuscript 3 is lighted with a light source 18, the reflective (transmitting) light is read in a line shape with the light receiving element 22 through the optical system to perform photoelectric conversion, and next reading is performed while slightly moving a relative position of the manuscript and the light source unit 19 with a transport system. This is repeated to read image information and the image information is outputted into a computer or the like as digital information by performing various image signal process at the image processing portion 23. A linear image sensor (a device in which a sensor element is arranged in a line shape) like a CCD (charge coupled device) is typically used as the light receiving element 22. Note that there is image signal process such as shading correction, Y correction, concentration correction, MTF correction, noise correction, and color correction.

Note that a drum scanner for plate making and a camera type scanner may be used at the scanner portion. A single element is used for an image sensor in the case of the drum scanner and both main scanning and sub scanning are performed automatically; therefore, an extremely high resolution can be obtained without depending on a resolution of a device. In addition, two-dimensional sensor is used for a camera type scanner as well as a digital camera.

A laser-beam printer in which a laser is combined with a xerography type is mostly used for the print portion of the digital copy machine. As illustrated in FIG. 2B and FIG. 4, the structure of the print portion in that case includes at least a laser scanner 25, a print unit (a charger 12, a photosensitive drum 11, a developer 13, and a fixing unit 15), and a paper supply portion 20. The laser scanner 25 converts the electrical signal 24 converted by the light receiving element 22 and the image processing portion 23 into laser light.

Here, a laser-beam printer is briefly described. Basically, the laser-beam printer has the same structure as the xerography type analog copy machine except that an image is reproduced with a small dot based on a digital signal from the scanner portion in forming the image over a photosensitive drum. A semiconductor laser is electrically modulated directly with an image signal to repeat flash of the laser. Sub scanning of the light emitted from the semiconductor laser is performed with a polyhedral reflecting mirror (polygon mirror) and Fθ lens through a collimating lens and main scanning thereof is performed by revolving the photosensitive drum; therefore, an electrostatic latent image is reproduced over the photosensitive drum. The following process is the same as the xerography type analog copy machine. The minuteness of a space between dots (dpi) results in the finely textured image, and the minuter the space is, the clearer a character or an image is.

The photoconductive layer of the photosensitive drum 11 in the laser-beam printer differs depending on a wavelength of a laser to be used. For example, Se is mainly used for a He—Cd laser (440 nm), and Se—Te, a-Si, or CdS is each mainly used for a He—Ne laser (632.8 nm). In addition, a-Si, OPC, or the like is mainly used for a semiconductor laser of GaAlAs (780 nm).

Note that a copy machine according to the invention may be capable of color copy. In this case, a manuscript 3 is irradiated with light emitted from a light source unit 19, and in a color copy, color is decomposed into RGB with a filter and each converted into signals. The signal of which color is decomposed is processed by a computer, which coverts the signal into YMC (three primary colors of yellow, magenta, and cyanide) and Bk (black). Then, as like a dry type, a toner is transferred to a piece of copy paper 14, and in a color copy, a toner different in color is transferred depending on a place according to a signal converted by the computer. Finally, the toner is fixed to a piece of paper by applying heat.

As described above, whether the manuscript 3 is copied or not can be controlled and, when the manuscript 3 can be copied, the copy can be performed in the foregoing manner. The copy machine 1 according to the invention is not limited to the foregoing structure as long as the R/W 2, the control portion 6, and the mechanism necessary for a copy are equipped.

Since the copy machine 1 according to the invention is equipped with the foregoing structure, whether a manuscript can be copied or not can be determined and/or controlled promptly; therefore, an illicit copy and an unnecessary copy can be prevented. In addition, throughput can be enhanced compared with the case where whether there is possibility of performing copying or not is determined by a barcode.

### Embodiment Mode 2

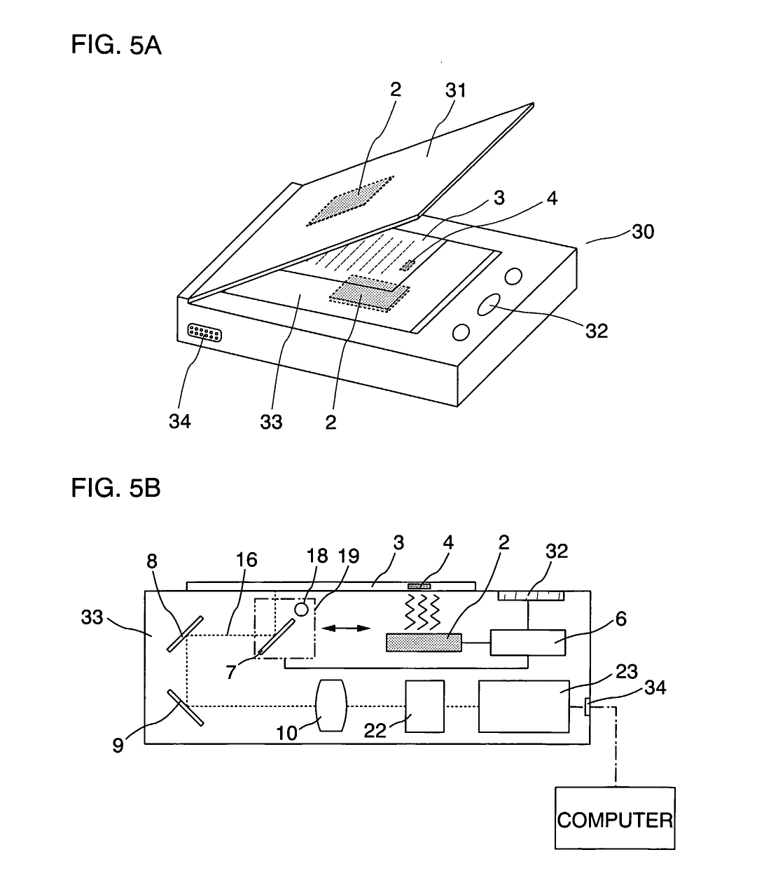

A scanner according to the present invention is described with reference to FIGS. 5A and 5B. FIG. 5A is a perspective view of the scanner according to the invention, and FIG. 5B is a block diagram illustrating a structure of the scanner according to the invention.

As illustrated in FIG. 5A, an R/W 2 for reading information on a semiconductor device 4 mounted on a manuscript 3 is provided in the interior of a scanner 30. As illustrated in FIG. 5B, the scanner 30 is provided therein with a scanner portion 33 (including at least an optical system (a light source unit 19, mirrors 7 to 9, and an imaging lens 10), a light receiving element 22, and an image processing portion 23). The R/W 2 is connected to at least the light source unit 19 of the scanner portion 33 via a control portion 6. Accordingly, whether the manuscript 3 is irradiated with light or not can be controlled, and as a result, whether the manuscript 3 is scanned (read) or not can be controlled. Note that the number of mirrors is not limited to the foregoing description.

In addition, the scanner 30 is provided with an operating portion 32 and a terminal 34 for connecting to other devices such as a computer. The operating portion 32 is connected to the R/W 2 or the control portion 6.

The R/W 2 may be provided in the interior of the scanner 30, in other words, in the same space as the scanner portion 33 or may be provided in a cover 31 for covering the manuscript 3. Besides, there is no limitation on a place to provide the R/W 2 as long as the place is capable of communicating with the semiconductor device 4 mounted on the manuscript 3. If required, the R/W 2 may be provided in a plurality of places.

The control portion 6 includes at least a CPU and a memory including ROM, RAM, nonvolatile memory, and the like, and has operations each for distinguishing whether the manuscript 3 can be copied or not and for controlling the scanning operation based on information on the semiconductor device 4 obtained by the R/W 2.

If required, a database may be connected to the control portion 6. At this time, not only information that determines whether copying can be performed or not which is compared with information on the semiconductor device 4 but also information that restricts the following copying or the like (in other words, new information to be written in) may be stored in the foregoing database.

Note that the control portion 6 and the database may be provided in the interior of the scanner 30 or in the cover 31 for covering the manuscript 3 or may be externally connected by a fixed-line or a wireless network.

The manuscript 3 is not limited to a manuscript (such as a piece of paper installed with a semiconductor device) made of a variety of paper as long as the semiconductor device 4 is mounted thereon. For example, the manuscript 3 may be a photograph, a special film such as an OHP sheet, or the like.

In addition, the structure of the R/W 2 and the semiconductor device 4 and a communication method between the R/W 2 and the semiconductor device 4 each the same as those of Embodiment Mode 1 can be employed.

Here, the scanner 30 may employ any structure, as long as the scanner 30 is equipped with the R/W 2 and the control portion 6, and with a function of converting information on position of a pixel on an image and information corresponding to spectral reflectivity (transmittance), which are obtained from a piece of paper, a photograph, or the like, into digital data to be outputted into a computer or the like.

Since the scanner 30 according to the invention is equipped with the foregoing structure, whether a manuscript can be copied or not can be determined and/or controlled promptly; therefore, an illicit copy and an unnecessary copy can be prevented. In addition, throughput can be enhanced compared with the case where whether there is possibility of performing copying or not is determined by a barcode.

### Embodiment Mode 3

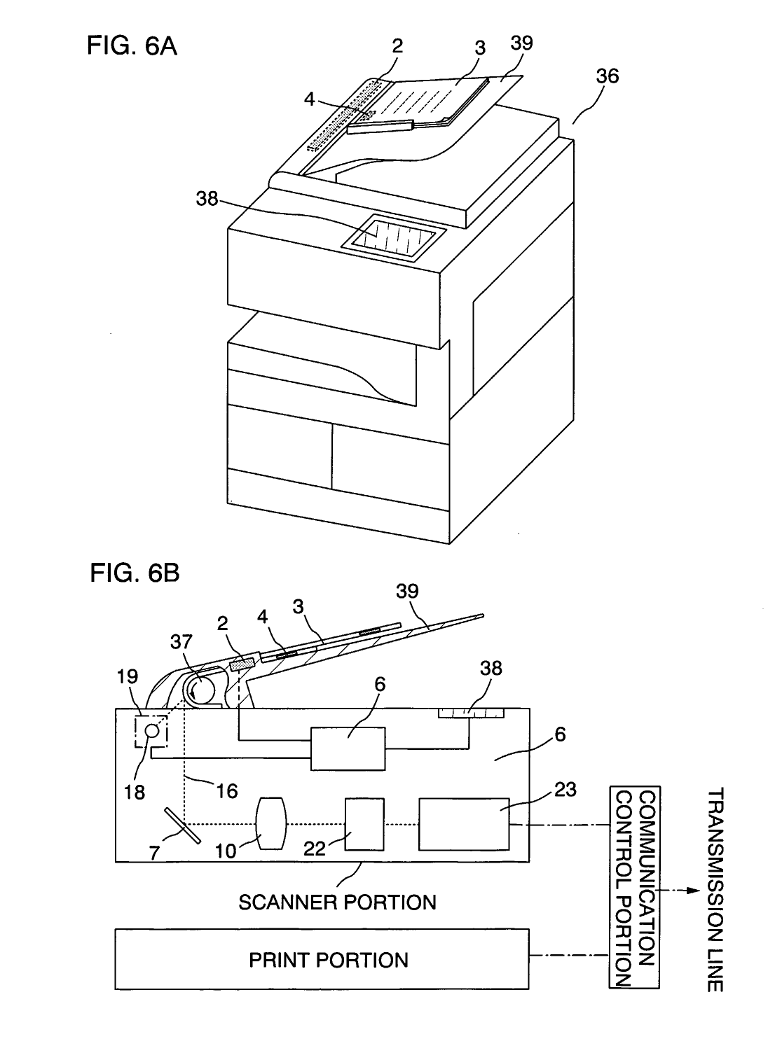

A facsimile (transmission device) according the present invention is described with reference to FIGS. 6A and 6B. FIG. 6A is a perspective view of the facsimile according to the invention, and FIG. 6B is a block diagram illustrating a structure of the facsimile according to the invention.

As illustrated in FIG. 6A, an R/W 2 for reading information on a semiconductor device 4 mounted on a manuscript 3 is provided in the interior of a facsimile 36. As illustrated in FIG. 6B, the facsimile 36 is provided therein with a scanner portion (including at least an optical system (a light source unit 19, a mirror 7, and an imaging lens 10), a light receiving element 22, and an image processing portion 23). The R/W 2 is connected to at least the light source unit 19 of the scanner portion via a control portion 6. Accordingly, whether the manuscript 3 is irradiated with light or not can be controlled, and as a result, whether the manuscript 3 is scanned or not and whether information on the manuscript 3 is sent or not can be controlled. Note that the number of mirrors is not limited to the foregoing description.

In addition, the facsimile 36 is provided with an operating portion 38. The operating portion 38 is connected to the R/W 2 or the control portion 6.

The R/W 2 may be provided in the interior of the facsimile 36, in other words, in the same space as the scanner portion or may be provided in a tray 39 for putting the manuscript 3 (see FIGS. 6A and 6B). Besides, there is no limitation on a place to provide the R/W 2 as long as the place is capable of communicating with the semiconductor device 4 mounted on the manuscript 3. If required, the R/W 2 may be provided in a plurality of places.

The control portion 6 includes at least a CPU and a memory including ROM, RAM, nonvolatile memory, and the like, and has operations each for distinguishing whether the manuscript 3 can be copied or not and for controlling the scanning operation based on information on the semiconductor device 4 obtained by the R/W 2.

If required, a database may be connected to the control portion 6. At this time, not only information that determines whether copying can be performed or not which is compared with information on the semiconductor device 4 but also information that restricts the following copying or the like (in other words, new information to be written in) may be stored in the foregoing database.

Note that the control portion 6 and the database may be provided in the interior of the facsimile 36 or in the tray 39 or may be externally connected by a fixed-line or a wireless network.

Typically, the manuscript 3 is a manuscript (a piece of paper installed with a semiconductor device or the like) made of a variety of paper installed with a semiconductor device.

In addition, the structure of the R/W 2 and the semiconductor device 4 and a communication method between the R/W 2 and the semiconductor device 4 each the same as those of Embodiment Mode 1 can be employed.

Here, the facsimile 36 may employ any structure, as long as the facsimile 36 is equipped with the R/W 2 and the control portion 6, and with a function of converting information on position of a pixel on an image and information corresponding to spectral reflectivity (transmittance), which are obtained from the manuscript 3, into digital data to be outputted into a communication control portion and a print portion that outputs the information received by the communication control portion. Herein, the communication control portion is connected to a transmission line (for example, a telephone line), which performs sending and receiving of the outputted information or inputted information.

Note that the facsimile according to the invention is not limited to the foregoing structure, as long as the facsimile converts information on the manuscript 3 such as a document, a photograph, a figure, or the like into an electrical signal and transmits afar using a radio wave or a telephone line to have a function of reproducing the information into another manuscript.

In this embodiment mode, a so-called drum scanning method is employed as a scanning method in scanning the manuscript 3. In this case, scanning is performed by coiling the manuscript 3 around a rotating roller 37 and moving the light source unit 19 in a rotating direction and a perpendicular direction (a perspective direction in FIG. 6B) while sending the manuscript 3. However, the scanning method is not limited to the drum scanning method, and a so-called flatbed scanning method, which performs scanning while keeping the manuscript 3 in a plane state, may also be employed.

In the case of using a facsimile, sometimes, a manuscript that has once sent to a specific person is resent due to one's carelessness. In such a case, information on the sent date and time, address, or the like are inputted into the semiconductor device 4 mounted on the manuscript 3 from the R/W 2 mounted on the facsimile according to the invention. Accordingly, attention can be drawn when the manuscript is resent.

Since the facsimile 36 according to the invention is equipped with the foregoing structure, whether a manuscript can be copied or not can be determined and/or controlled promptly; therefore, an illicit copy and an unnecessary copy can be prevented. In addition, throughput can be enhanced compared with the case where whether there is possibility of performing copying or not is determined by a barcode.

### Embodiment Mode 4

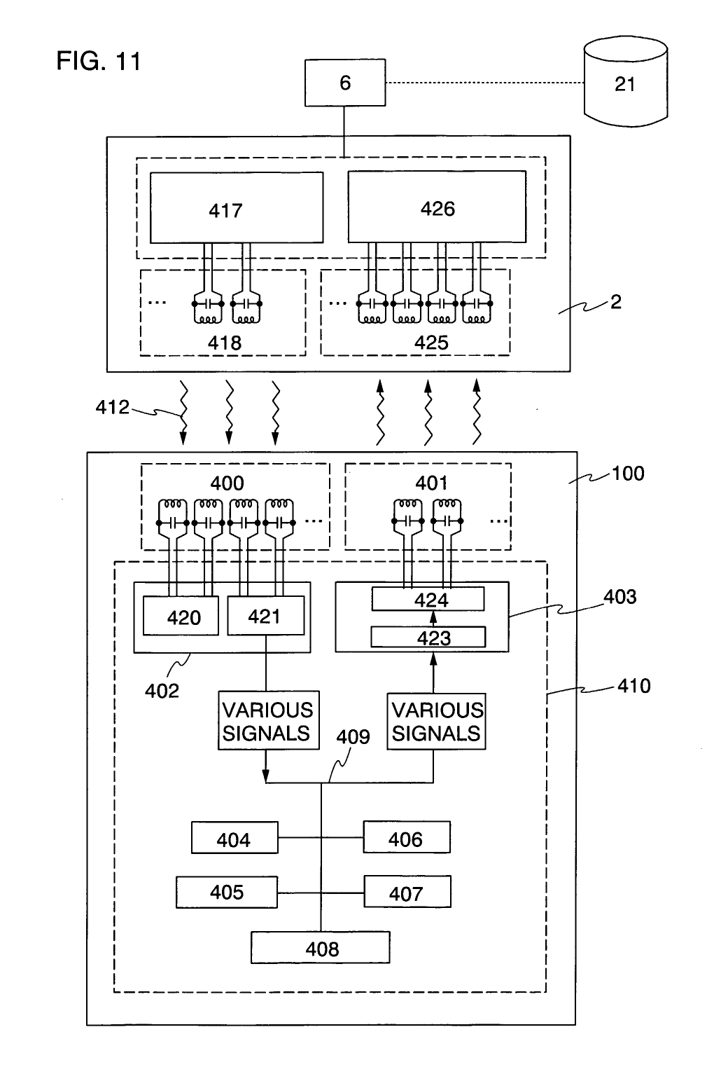

This embodiment mode describes an example of a communication principle between an ID chip 100 mounted on a manuscript 3 and an R/W 2 according to the present invention with reference to FIG. 11.

FIG. 11 is a block diagram illustrating the ID chip 100 and the R/W 2. Reference numeral 400 denotes an input antenna; and 401, an output antenna. In addition, reference numeral 402 denotes an input interface; and 403, an output interface. Note that the number of various antennas is not limited to the number of those illustrated in FIG. 11. Further, the shape of the antenna is not limited to a coil shape. An electromagnetic wave 412 received from the R/W 2 by the input antenna 400 is demodulated and converted into DC at the input interface 402. Thereafter, the electromagnetic wave 412 is supplied to various circuits such as a CPU 404, a coprocessor 405, a ROM 406, a RAM 407, and a nonvolatile memory 408 via a bus line 409.

Herein, the coprocessor 405 serves as a processor that helps a CPU serving as a main computer for controlling all kinds of processing of the ID chip 100. The coprocessor 405 usually serves as an instruction execution unit only for code processing. In addition, an EPROM, an EEPROM, an UV-EPROM, a flash memory, a nonvolatile memory, or the like that can rewrite information more than once may be used for the nonvolatile memory 408.

The foregoing memories are classified into a program memory (a space for storing a program), a working memory (a space for temporarily saving data in a process of program execution), and a data memory (a space for storing fixed data dealt by a program as well as information specific to the ID chip 100 mounted on the manuscript 3) depending on its operation and characteristic. Generally, a ROM is used as the program memory, and a RAM is used as the working memory. In addition, the RAM also serves as a buffer during communication with the R/W 2. Further, the EEPROM is generally used in order to store data inputted as a signal in a determined address.

Then, the information specific to the ID chip 100 stored in the memory is converted into a signal at the foregoing various circuits and further modulated at the output interface 403 to be sent to the R/W 2 by the output antenna 401. Here, the input interface 402 is provided with a rectification circuit 420 and a demodulation circuit 421. AC power supply voltage inputted from the input antenna 400 is rectified at the rectification circuit 420 and supplied to the foregoing various circuits as DC power supply voltage. In addition, various AC signals inputted from the input antenna 400 are demodulated at the demodulation circuit 421. Then, various signals waveform-shaped by demodulation are supplied to the various circuits.

In addition, the output interface 403 is provided with a modulation circuit 423 and an amplifier 424. The various signals inputted into the output interface 403 from the various circuits are modulated at the modulation circuit 423, and amplified, or buffered and amplified at the amplifier 424, then, sent to a terminal device like the R/W 2 from the output antenna 401. The signals sent from the ID chip 100 are received by an input antenna 425 of the R/W 2, demodulated at an input interface 426, and then sent to a control portion 6 to be data-processed. Accordingly, the information specific to the ID chip 100 mounted on the manuscript 3 can be identified.

Note that the foregoing control portion 6 has software having a function of processing information on the ID chip 100 mounted on the manuscript 3; however, information processing may be performed by hardware.

The various circuits illustrated in FIG. 11 are just one mode. The various circuits mounted on the ID chip 100 and on the R/W 2 are not limited to the foregoing circuits. Although FIG. 11 illustrates an example of using an antenna for a non-contact type, the case of a non-contact type is not limited thereto. Data may be sent and received with light by using a light-emitting element, light, or the like.

In FIG. 11, the input interface 402 and the output interface 403, each of which includes analog circuits such as the rectification circuit 420, the demodulation circuit 421, and the modulation circuit 423; the CPU 404; various memories; and the like are formed using one thin film integrated circuit 410. However, this structure is just one example and the invention is not limited thereto. For example, the input interface 402 and the output interface 403, each of which includes analog circuits such as the rectification circuit 420, the demodulation circuit 421, and the modulation circuit 423, can be provided to the ID chip 100. The CPU 404, the various memories, and the like can be formed by a thin film integrated circuit composed of a TFT.

### Embodiment 1

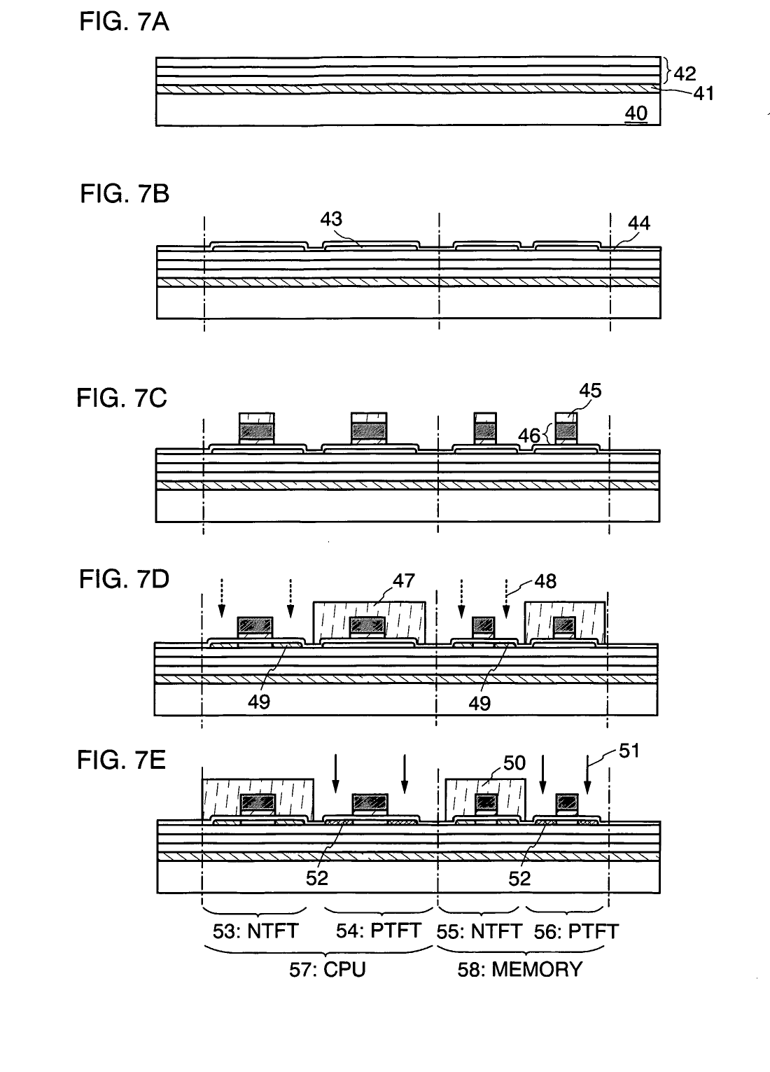

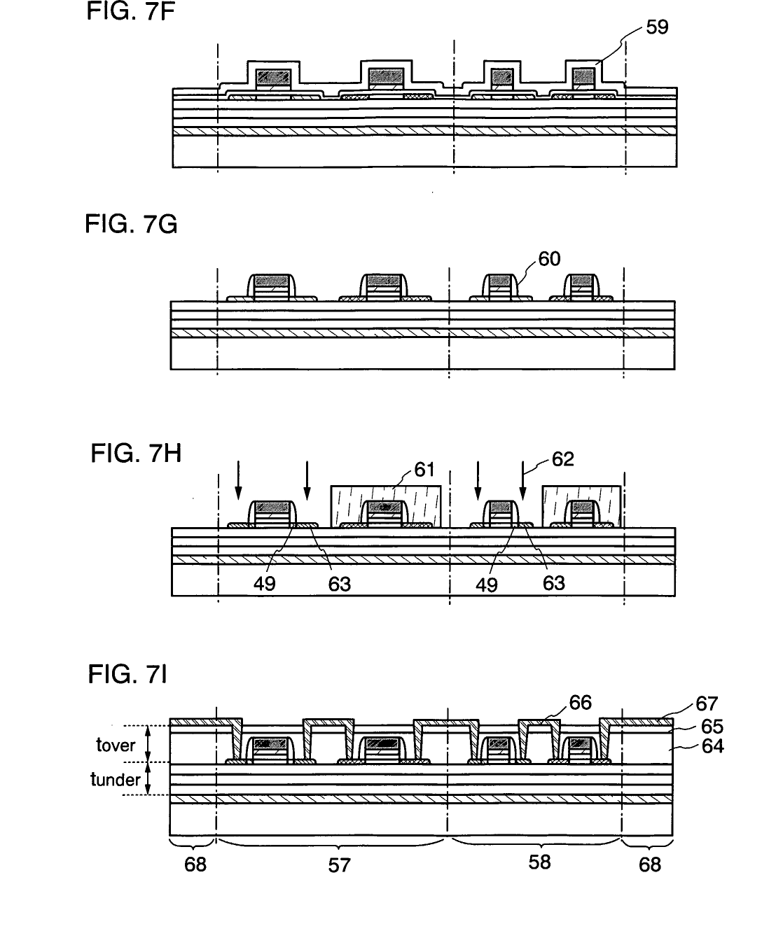

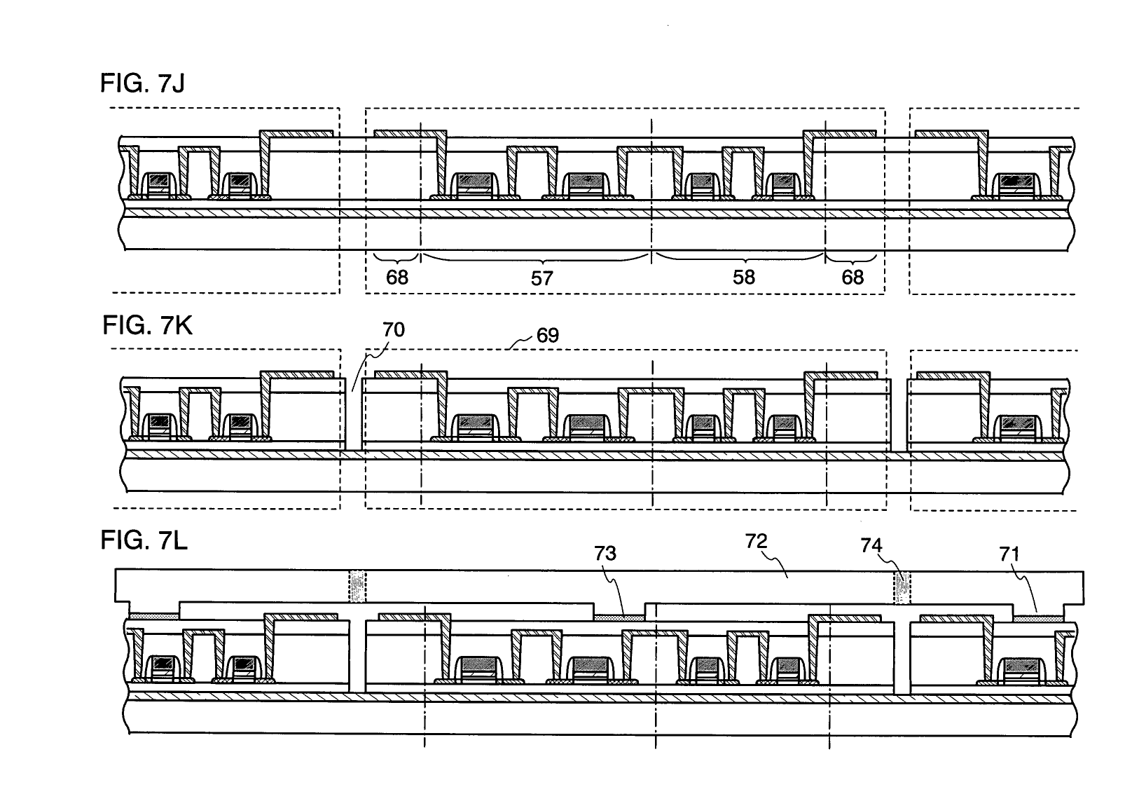

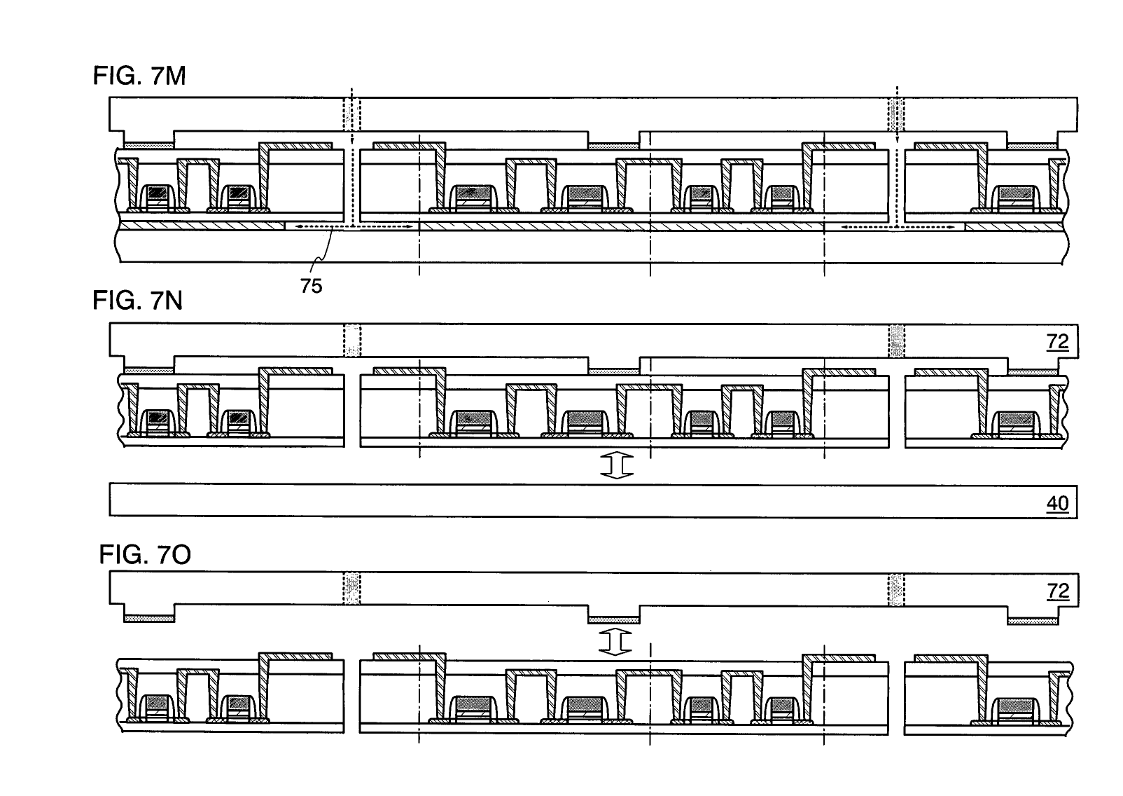

This embodiment describes a specific manufacturing method of a piece of paper installed with an ID chip which is typically used as a manuscript 3 according to the present invention with reference to FIGS. 7A to 7O, FIGS. 8A and 8B, and FIG. 10B. The manufacturing method is described here for simplification by showing a cross-sectional structure of a CPU and its memory using an n-type TFT and a p-type TFT in a mounted ID chip.

First, a peeling layer 41 is formed over a substrate 40 (FIG. 7A). Here, an a-Si film (amorphous silicon film) in 50 nm thick is formed over a glass substrate (for example, a Corning 1737 substrate) by a sputtering method. In addition to a glass substrate, substrates such as a quartz substrate, a substrate including an insulating material such as alumina, a silicon wafer substrate, a thermal silicon oxide substrate, an SIMOX substrate, or a heat-resistant plastic substrate that can withstand processing temperatures in subsequent processes can be used as the substrate.

In addition to the amorphous silicon, a layer containing silicon as its main component such as polycrystalline silicon, single-crystal silicon, SAS (also referred to as semi-amorphous silicon), or microcrystalline silicon can be used as the peeling layer. These peeling layers may be formed by a CVD method or the like instead of the sputtering method. It is desirable that the film thickness of the peeling layer is to be from 50 nm to 54 nm. In the case of the SAS, the film thickness may be from 30 nm to 50 nm.

Next, a protective film 42 (also referred to as a base film or a base insulating film) is formed over the peeling layer 41 (FIG. 7A). Although a three-layered structure of a SiON film in 100 nm thick, a SiNO film in 50 nm thick, and a SiON film in 100 nm thick is employed here, the materials, the film thicknesses, or the number of laminations are not limited thereto. For example, a heat-resistant resin such as siloxane in a thickness of from 0.5 to 3 μm may be formed by a spin coating method, a slit coating method, a droplet discharging method, or the like instead of the lower SiON film. Alternatively, a silicon nitride film (for example, SiN, Si₃N₄, or the like) may be used. It is preferable that each film thickness is to be from 0.05 to 3 μm, and the film thickness can be arbitrarily selected within the range.

A silicon oxide film can be formed by a thermal CVD method, a plasma CVD method, an atmospheric CVD method, or a bias ECRCVD method using a mixed gas such as a SiH₄—O₂ mixed gas or a TEOS (tetraethoxysilane)-O₂ mixed gas. The silicon nitride film can be formed typically by a plasma CVD method using a SiH₄—NH₃ mixed gas. The SiON film or the SiNO film can be formed typically by a plasma CVD method using a SiH₄—N₂O mixed gas.

In the case where a material containing silicon such as a-Si as a main component is used as the peeling layer 41 and an island-shaped semiconductor film 43 to be mentioned later, SiOₓN_{y} may be used as the protective film 42 in contact therewith from the viewpoint of ensuring adhesiveness.

Next, TFTs constituting a CPU and a memory of a thin film integrated circuit portion are formed over the protective film 42. In addition to the TFTs, thin film active elements such as organic TFTs and thin film diodes can also be formed.

In a method for manufacturing the TFTs, the island-shaped semiconductor films 43 are formed first over the protective film 42 (FIG. 7B). The island-shaped semiconductor films 43 are formed using an amorphous semiconductor, a crystalline semiconductor, or a semi-amorphous semiconductor. In any case, it is possible to use a semiconductor film containing a material such as silicon or silicon-germanium (SiGe) as its main component.

Here, amorphous silicon in 70 nm thick is formed and treatment with a solution containing nickel is further performed to the surface of the amorphous silicon. Further, a crystalline silicon semiconductor film is obtained by a thermal crystallization process at temperatures from 500 to 750° C., and laser crystallization is performed to improve the crystallinity. A plasma CVD method, a sputtering method, an LPCVD method, or the like may be used as the method for deposition. A laser crystallization method, a thermal crystallization method, or a thermal crystallization method using another catalyst (such as Fe, Ru, Rh, Pd, Os, Ir, Pt, Cu, or Au) may be used as a method for crystallization, and furthermore, the methods described above may be used alternately more than once.

A continuous-wave laser may be used for crystallization treatment of the semiconductor film having an amorphous structure. In order to obtain a large-grain crystal by crystallization, it is preferable to use a continuous-wave solid laser and apply any of the second to fourth harmonics of the fundamental wave (the crystallization in this case is referred to as “CWLC”). Typically, the second harmonic (532 nm) or the third harmonic (355 nm) of a Nd:YVO₄ laser (fundamental wave: 1064 nm) is preferably applied. In the case of using a continuous-wave laser, laser light emitted from a continuous-wave YVO₄ laser with 10 W output is converted into a harmonic by a non-linear optical element. There is also a method in which an YVO₄ crystal or a GdVO₄ crystal and a non-linear optical element are put in a resonator to emit a harmonic. Then, rectangular-shaped or elliptic-shaped laser light is preferably formed on a surface to be irradiated by an optical system to irradiate an object to be processed. In this case, a power density of approximately between 0.01 and 100 MW/cm² (preferably, from 0.1 to 10 MW/cm²) is necessary. The semiconductor film may be irradiated by being moved at a speed of approximately between 10 and 2000 cm/s relatively with respect to the laser light.

In the case of using a pulsed laser, a frequency band of several tens to several hundreds Hz is generally used. However, a pulsed laser with a repetition frequency of 10 MHz or more, which is much higher than the frequency band, may be used. The period from laser irradiation to a semiconductor film by a pulsed laser to perfect solidification of the semiconductor film is said to be several tens to several hundreds nsec. Thus, the foregoing use of the high frequency band allows emitting the next pulsed laser light during the period from melting of a semiconductor film by laser light to solidification thereof. Accordingly, a solid-liquid interface can be continuously moved in a semiconductor film unlike the case of using a conventional pulsed laser; therefore, a semiconductor film that has crystal grains grown continuously along the scanning direction is formed. Specifically, an assembly of crystal grains having a width of approximately 10 to 30 μm in the scanning direction and a width of approximately 1 to 5 μm in a direction perpendicular to the scanning direction can be formed. The formation of single-crystal grains long extended along the scanning direction makes it possible to form a semiconductor film in which there are almost no crystal grain boundaries in at least a channel direction of a TFT.

In the case of using siloxane that is a heat-resistant organic resin for part of the protective film 42, heat can be prevented from leaking from the semiconductor film during the foregoing crystallization; therefore, the crystallization can be performed efficiently.

According to the foregoing method, the crystalline silicon semiconductor film is obtained, where it is desirable that crystals are oriented in a source-channel-drain direction and the thicknesses of the crystal layers are to be from 20 to 200 nm (typically, from 40 to 170 nm, more preferably, from 50 to 150 nm). Thereafter, an amorphous silicon film for gettering the metal catalyst is formed over the semiconductor film with an oxide film interposed therebetween, and gettering treatment is performed by heat treatment at temperatures from 500 to 750° C. Further, boron ions of the dose amount having order of 10¹³/cm² are injected into the crystalline silicon semiconductor film in order to control a threshold voltage of a TFT element. Then, the island-shaped semiconductor films 43 are formed by etching with a resist as a mask.

In forming the crystalline semiconductor film, the crystalline semiconductor film can be obtained also by directly forming a polycrystalline semiconductor film by using disilane (Si₂H₆) and germanium tetrafluoride (GeF₄) as a material gas and employing an LPCVD (low-pressure CVD) method. In this case, the gas flow rate is Si₂H₆/GeF₄=20/0.9, the deposition temperature is from 400 to 500° C., and He or Ar is used as a carrier gas. However, the conditions are not limited thereto.

It is preferable that a channel region in the TFT is particularly added with hydrogen or halogen of from 1×10¹⁹ to 1×10²² cm⁻³, preferably from 1×10¹⁹ to 5×10²⁰ cm⁻³, or from 1×10¹⁹ to 2×10²¹ cm⁻³ in the case of SAS. In any case, the amount of hydrogen or halogen included in the channel region in the TFT may be more than that included in a single crystal to be used for an IC chip. This makes it possible to terminate local cracks with hydrogen or halogen even when the local cracks are generated in a TFT portion.

When a SAS (semi-amorphous semiconductor) or the like is used, a crystallization process of the semiconductor film (a high-temperature heat treatment process) can be omitted. In this case, a chip can also be formed directly on a flexible substrate. According to the invention, although a silicon wafer is not used in principle, a silicon wafer may be used as a substrate to be peeled before transferring to a flexible substrate or the like.

Next, a gate insulating film 44 is formed over the island-shaped semiconductor films 43 (FIG. 7B). It is preferable that a method for forming a thin film such as a plasma CVD method or a sputtering method is used to form a single layer or stacked layers of a layer containing silicon nitride, silicon oxide, silicon nitride oxide, or silicon oxynitride as the gate insulating film. In the case of the stacked layers, for example, a three-layered structure of a silicon oxide film, a silicon nitride film, and a silicon oxide film from the substrate side may be preferably employed.

A gate electrode 46 is formed (FIG. 7C). Here, the gate electrode 46 is formed performing etching by using a resist 45 as a mask after stacking and forming Si (silicon) and W (tungsten) by a sputtering method. Of course, the material, the structure, or the manufacturing method of the gate electrodes 46 is not limited thereto and can be appropriately selected. For example, a stacked structure of an n-type impurity doped or non-doped Si (silicon) and NiSi (nickel silicide) or a stacked structure of TaN (tantalum nitride) and W (tungsten) may be employed. Alternatively, various conductive materials may be used to form the gate electrode 46 in a single layer.

Instead of the resist mask, a mask such as SiOₓ may be used. In this case, a process of forming a mask such as SiOₓ or SiON (which is called a hard mask) by patterning is added. However, since the mask is less reduced during etching than the resist, a gate electrode layer with a desired width can be formed. Alternatively, a droplet discharging method may be used to form the gate electrode 46 selectively without using the resist 45.

Various materials can be selected depending on the function of the conductive film as the conductive materials. In the case of forming the gate electrode and an antenna at the same time, the materials may be selected in consideration of their functions.

In forming the gate electrode by etching, although a mixed gas of CF₄, Cl₂, and O₂ or a Cl₂ gas is used as an etching gas, the etching gas is not limited thereto.

Next, portions to become p-channel TFTs 54 and 56 are covered with a resist 47. The island-shaped semiconductor films to become n-channel TFTs 53 and 55 are doped with an impurity element 48 (typically, P (phosphorus) or As (arsenic)) imparting n-type conductivity to form a low-concentration impurity region with the gate electrode as a mask (a first doping process illustrated in FIG. 7D). The first doping process is performed under the following conditions: dose amount of from 1×10¹³ to 6×10¹³/cm² and accelerating voltage of from 50 to 70 keV. However, the conditions are not limited thereto. According to this first doping process, doping through the gate insulating film 44 is performed to form a pair of low-concentration impurity regions 49. The first doping process may be performed entirely without covering the p-channel TFT regions with the resist.

After removing the resist 47 by an ashing method or the like, a resist 50 is newly formed to cover the n-channel TFT region. The island-shaped semiconductor films to become the p-channel TFTs 54 and 56 are doped with an impurity element 51 (typically, B (boron)) imparting p-type conductivity to form a high-concentration impurity region with the gate electrode as a mask (a second doping process illustrated in FIG. 7E). The second doping process is performed under the following conditions: dose amount of from 1×10¹⁶ to 3×10¹⁶/cm² and accelerating voltage of from 20 to 40 keV. According to this second doping process, doping through the gate insulating film 44 is performed to form a pair of high-concentration impurity regions 52 of p-type conductivity.

After removing the resist 50 by an ashing method or the like, an insulating film 59 is formed over the substrate (FIG. 7F). Here, a SiO₂ film in 100 nm thick is formed by a plasma CVD method. Thereafter, the insulating film 59 and the gate insulating film 44 are etched and removed to form sidewalls 60 in a self-alignment manner (FIG. 7G). A mixed gas of CHF₃ and He is used as the etching gas.

The method for forming the sidewalls 60 is not limited to the foregoing method. For example, after forming the insulating film 59, the entire surface of the substrate may be covered with a resist, and the resist, the insulating film 59, and the gate insulating film 44 may be etched and removed by an etching back method to form the sidewall 60 in a self-alignment manner. Further, if the insulating film 59 is formed on the both sides of the substrate due to the property of the film forming method, back grinding is performed using the resist as a mask to remove the insulating film formed over the backside of the substrate, and then an etching back treatment may be performed.

The insulating film 59 may have a laminated layer structure of two or more layers. For example, a two-layered structure of a SiON (silicon oxynitride) film in 100 nm thick and an LTO (Low Temperature Oxide) film in 200 nm thick is employed. In this case, the SiON film is formed by a plasma CVD method and a SiO₂ film is formed by a low pressure CVD method as the LTO film. The shape of the sidewall 60 is not limited to that illustrated in FIG. 7G. The sidewall 60 may have an L-shape or a combined shape of an L-shape and a circular shape.

The foregoing sidewall functions as a mask for forming a low-concentration impurity region or a non-doped offset region below the sidewall 60 when doping of a high-concentration n-type impurity element is performed later. In any of the foregoing methods for forming the sidewalls, the condition for etching back and the thickness of the insulating film 59 may be appropriately changed depending on the desired width of a low concentration impurity region or an offset region.

Next, a resist 61 is newly formed to cover the p-channel TFT regions, and doping of an impurity element 62 imparting n-type conductivity (typically, P or As) is performed to form a high-concentration impurity region (a third doping process illustrated in FIG. 7H) by using the gate electrode 46 and the sidewall 60 as masks. The third doping process is performed under the following conditions: dose amount of from 1×10¹³ to 5×10¹⁵/cm² and accelerating voltage of from 60 to 100 keV. According to this third doping process, doping through the gate insulating film 44 is performed to form a pair of high-concentration impurity regions 63 of n-type conductivity.

After removing the resist 61 by an ashing method or the like, the impurity regions may be thermally activated. For example, after forming a SiON film in 50 nm thick, heat treatment is preferably performed at 550° C. for 4 hours in a nitrogen atmosphere. In addition, after forming a SiNₓ film containing hydrogen in 100 nm thick, defects of the crystalline semiconductor film can be improved by heat treatment at 410° C. for 1 hour in a nitrogen atmosphere. For example, this is a process of terminating dangling bonds existing in crystalline silicon, which is referred to as a hydrogenation treatment process. Further, thereafter, a SiON film in 600 nm thick may be formed as a cap insulating film protecting the TFTs. The hydrogenation treatment process may be performed after forming the SiON film. In this case, the SiON film can be formed continuously over a SiNₓ film. In this way, the three-layered insulating films of SiON, SiNₓ, and SiON are formed over the TFTs. However, the structures or the materials of the insulating films are not limited thereto. Since these insulating films also have a function of protecting the TFTs, it is as much desirable to form the insulating films as possible.

Next, an interlayer film 64 is formed over the TFTs (FIG. 7I). Polyimide, acryl, or polyamide, or a heat-resistant organic resin such as siloxane can be used for the interlayer film 64. In forming the interlayer film 64, a spin-coating method, a dipping method, a spray coating method, a droplet discharging method (such as an ink-jet method, a screen-printing method, an off-set printing method), a doctor knife, a roll coater, a curtain coater, a knife coater, or the like can be employed depending on the material of the interlayer film. Further, an inorganic material may also be used. In this case, silicon oxide, silicon nitride, silicon oxynitride, PSG (phosphorus silicate glass), PBSG (phosphorus boron silicate glass), BPSG (borophosphosilicate glass), an alumina film, or the like can be used. Note that these insulating films may be stacked to form the interlayer film 64.

Further, a protective film 65 may be formed over the interlayer film 64. The protective film 65 can be formed using a film containing carbon such as DLC (Diamond Like Carbon) or carbon nitride (CN), a silicon oxide film, a silicon nitride film, a silicon nitride oxide film, or the like. In forming the protective film 65, a plasma CVD method, an atmospheric plasma method, or the like can be employed. Alternatively, a photosensitive or a nonphotosensitive organic material such as polyimide, acrylic, polyamide, resist, or benzocyclobutene, or a heat-resistant resin such as siloxane may be used.

Note that a filler may be mixed into the interlayer film 64 or the protective film 65 in order to prevent film detachment or a crack of these films due to stress generated by a difference of a thermal expansion coefficient between the interlayer film 64 or the protective film 65 and a conductive material or the like of a wiring to be formed at a subsequent process.

A contact hole is formed by etching after forming a resist. A wiring 66 for connecting TFTs and a connection wiring 67 to be connected to an antenna are formed (FIG. 7I). When the contact hole is opened, a mixed gas of CHF₃ and He is used for an etching gas to be used; however, the etching gas is not limited thereto.

The wiring 66 or the connection wiring 67 has a five-layered structure in which Ti, TiN, Al—Si, Ti, and TiN are stacked over Ti from the substrate side. The wiring 66 or the connection wiring 67 is preferably formed by a sputtering method and then patterned. The generation of hillocks can be prevented during resist baking at the time of patterning the wiring by mixing Si into the Al layer. In addition, Cu of approximately 0.5% may be mixed instead of the Si. Hillock resistance can be further improved by sandwiching the Al—Si layer with Ti or TiN. At the patterning, the foregoing hard mask of SiON or the like is preferably used. The material and the forming method of these wirings are not limited thereto, and the foregoing material for forming the gate electrode may be employed.

Alternatively, an alloy containing aluminum and nickel is desirable to be used for the wiring 66 or the connection wiring 67. In addition, this alloy may further contain carbon, cobalt, iron, silicon, or the like. For example, a preferable rate of the content is as follows: 0.1 to 3.0 atomic % of carbon; 0.5 to 7.0 atomic % of an element containing at least one kind of nickel, cobalt, and iron; 0.5 to 2.0 atomic % of silicon. These materials have one of properties that the resistance is low to be from 3.0 to 5.0 Ωcm.

There is a problem that corrosion occurs due to the material of an antenna (for example, ITO) when Al is especially used for the connection wiring 67. Even in such a case, when Al (or an Al—Si alloy) has a stacked structure by being sandwiched between Ti or TiN, favorable contact with ITO can be obtained. For example, a stacked structure of Al and Ti over Ti is preferably employed. On the other hand, since the foregoing Al—C alloy, Al—C—Ni alloy, or the like has oxidation-reduction potential quite similar to that of a transparent conductive film such as ITO, direct contact with the antenna is possible even without a stacked structure (without being sandwiched between Ti, TiN, or the like). When etching of these alloys is performed using a resist mask, wet etching is preferably performed. In this case, phosphoric acid or the like can be used as the etchant.

In forming the wiring 66 or the connection wiring 67, patterning may be performed using a resist mask after forming a film over an entire surface by a sputtering method, or a droplet discharging method may be used for forming the wiring selectively with a nozzle. Note that the droplet discharging method here also includes an offset printing method and a screen printing method as well as an ink-jet method. The wiring and the antenna may be formed at the same time, or one of them may be formed prior to the other and the other may be stacked thereon.

Although this embodiment describes the case of forming a TFT region having a CPU 57, a memory 58, and the like separately from an antenna connection portion 68, this embodiment can also be applied to the case of integrating the TFT region and the antenna.

Through the foregoing steps, a thin film integrated circuit portion including TFTs is completed. Although a top-gate structure is employed in this embodiment, a bottom-gate structure (reverse stagger structure) may also be employed. The materials of the base insulating film, the interlayer insulating film, and the wiring are mainly provided in a region where there is no thin film active element portion (active element) such as a TFT, and it is preferable that the region occupies 50% or more of the entire thin film integrated circuit portion, preferably 70 to 95% thereof. This makes it easier to bend and treat an ID chip 100 that is a completed article. In this case, it is preferable that the island-shaped semiconductor region (island) of active elements including the TFT portions occupies 1 to 30%, preferably 5 to 15%, of the entire thin film integrated circuit portion.

In addition, as illustrated in FIG. 7I, it is desirable to control the thickness of the upper and the lower protective film and the interlayer film so that the distance (t_{under}) from the semiconductor layer of the TFT to the lower protective film and the distance (tₒᵥₑᵣ) from the semiconductor layer to the upper interlayer film (a protective film in the case where the protective film is formed) are equal or substantially equal to each other in the thin film integrated circuit portion. By locating the semiconductor layer in the center of the thin film integrated circuit portion in this way, stress to the semiconductor layer can be eased, and cracks can be prevented from being generated.

The TFTs manufactured according to this embodiment have a S value (subthreshold value) of 0.35 V/dec or less (preferably, 0.07 to 0.25 V/dec) and a mobility of 10 cm²/V·sec or more, and further have a characteristic of 1 MHz or more, preferably 10 MHz or more on the level of ring oscillator (at 3 to 5 V) or have a frequency characteristic per gate of 100 kHz or more, preferably 1 MHz or more (at 3 to 5 V).

After a plurality of thin film integrated circuit portions is formed over the substrate 40 (FIG. 7J), a groove 70 is formed by dicing and the plurality of thin film integrated circuit portions is isolated for each ID chip to obtain thin film integrated circuit portions 69 (FIG. 7K). In this case, a blade dicing method using a dicing device (dicer) is commonly used. The blade is a grinding stone into which a diamond abrasive is implanted, which has a width of approximately 30 to 50 μm. By rapidly spinning this blade, the thin film integrated circuit portions are isolated for each ID chip. An area necessary for dicing is referred to as a street, which preferably has a width of 80 to 150 μm in consideration of damage to the elements.

In addition to the dicing, a method such as scribing or etching using of a mask can be employed. In the case of the scribing, there are methods such as a diamond scribing method and a laser scribing method. In the case of employing the laser scribing method, linear laser light with power of 200 W to 300 W emitted from a pulsed laser resonator, for example, a fundamental wave of 1064 nm in wavelength, the second harmonic of 532 nm in wavelength, or the like of a Nd:YAG laser, can be used.

In the case of the etching, the elements can be separated from each other by dry etching after forming a mask pattern according to processes of light-exposure and development. In the dry etching, an atmospheric plasma method may also be used. Although a chlorine-based gas typified by Cl₂, BCl₃, SiCl₄, CCl₄, or the like, a fluorine-based gas typified by CF₄, SF₆, NF₃, CHF₃ or the like, and O₂ is used as a gas for dry etching, the gas for dry-etching is not limited thereto. The etching can also be performed by using atmospheric plasma. In this case, a mixed gas of CF₄ and O₂ is preferably used as the etching gas. The groove 70 may be formed by etching more than once using different kinds of gasses. Of course, the groove 70 may also be formed by wet etching.

When the groove 70 is formed, the groove may have a depth to the point that at least a surface of the peeling layer is exposed, and it is desirable that the method such as dicing is appropriately controlled in order not to scratch the substrate so that the substrate 40 can be used repeatedly.

Next, a jig 72 (supporting substrate) with protrusion 71 is attached to each of the thin film integrated circuits portions 69 with an adhesive agent 73 interposed therebetween (FIG. 7L). The jig has a function of temporarily fixing the plurality of thin film integrated circuit portions in order to prevent the thin film integrated circuit portions from separating discretely after removing the peeling layer. It is desirable that the jig has a structure that has the protrusions 71 and that is a comb-like, as illustrated in FIG. 7L, in order to make it easier to introduce a gas or liquid including halogen fluoride later. However, a flat jig may also be used. More desirably, an opening 74 may also be provided in order to make it easier to introduce a gas or liquid including halogen fluoride later.

For example, a glass substrate, a quartz substrate including silicon oxide as its main component, a stainless (SUS) substrate, and the like, which are not damaged by halogen fluoride, can be used as the jig 72. As long as a material that is not damaged by halogen fluoride is used, the jig is not limited to these substrates.

Here, a material that can be peeled easily is used for the adhesive agent 73. An adhesive agent capable of adhering again is preferably used after peeling.

Next, an a-Si film that is the peeling layer is etched and removed by introducing a halogen fluoride gas 75 into the groove 70 (FIG. 7M). A low pressure CVD apparatus is used here to etch and remove the a-Si film under the following conditions: ClF₃ (chlorine trifluoride) gas, temperature at 350° C., a flow rate at 300 sccm, pressure at 8×10² Pa (6 Torr), and a time for 3 hours. However, the conditions, which are not limited thereto, may be appropriately changed. Alternatively, a mixed gas of ClF₃ gas and nitrogen may be used, where the flow rate of the both gases can be appropriately set. Besides ClF₃, a gas such as BrF₃ or ClF₂ may also be used.

While there is a feature that silicon is selectively etched by halogen fluoride such as ClF₃, silicon oxide (SiOₓ), silicon nitride (SiNₓ), or silicon oxynitride (SiOₓN_{y} or SiNₓOy) is hardly etched. Accordingly, the peeling layer 41 is etched as time passes, so that the substrate 40 can finally be peeled (FIG. 7N). On the other hand, since the protective film that is a base film, an interlayer film, or a protective film including a material such as silicon oxide, silicon nitride, silicon oxynitride, or a heat-resistant resin is hardly etched, damage to the thin film integrated circuits can be prevented. The substrate 40 that has been peeled can be, of course, reused, which leads to more reduction in cost than the case of grinding a silicon wafer in a conventional manner.

Next, the adhesion of the adhesive agent 73 is reduced or lost by UV-light irradiation to separate the jig 72 from the thin film integrated circuit portions 69 (FIG. 7O). It is preferable to reuse the jig 72 for reduction in cost.

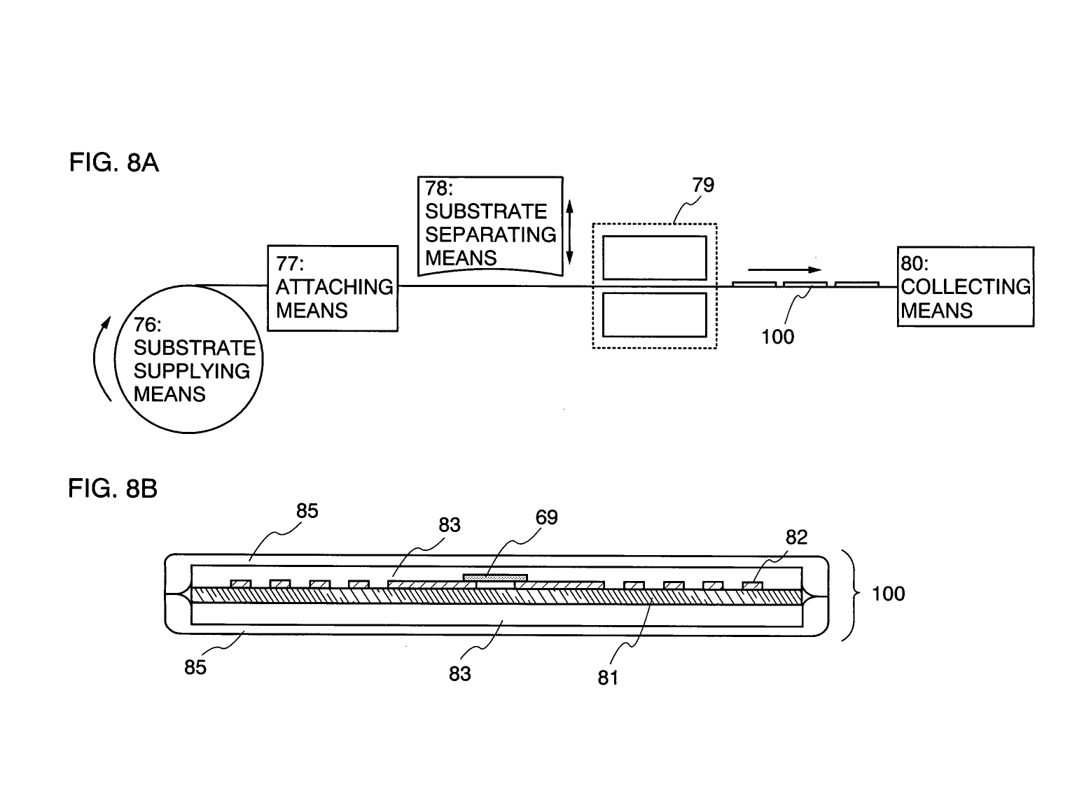

After forming each thin film integrated circuit portion 69, for example, coating illustrated in FIGS. 8A and 8B is performed.

FIGS. 8A and 8B illustrate a schematic diagram of a manufacturing line of an ID chip 100 and a magnified drawing of the ID chip as a completed article. First, as illustrated in FIG. 8A, a material that is to be an inlet substrate 81 (see FIG. 8B) of the ID chip 100 is supplied from a substrate supplying means 76. The inlet substrate 81 may have a single layer structure or a laminated layer structure.

An antenna 82 is formed in the inlet substrate 81 in advance. The following material can typically be used as a conductive material of the antenna 82: Ag, Au, Al, Cu, Zn, Sn, Ni, Cr, Fe, Co, Ti, ITO, or ITSO; or an alloy containing the elements. Note that the antenna 82 is formed to contain a material having sufficient malleability and ductility, and more preferably, is formed to be thick enough to endure stress due to transformation. Further, the antenna 82 may be covered with a protective film after being formed.

Pattering may be performed using a resist mask after forming a film over entire surface of the substrate by sputtering, or a droplet discharging method may be used for forming selectively with a nozzle as a method for forming the antenna 82. Note that the droplet discharging method here includes an offset printing method and a screen printing method as well as an ink-jet method.

Next, the thin film integrated circuit portion 69 is attached to a desired region of the inlet substrate 81 by an attaching means 77. At this time, an anisotropic conductive film (ACF), an ultrasonic bonding method, a UV bonding method, and the like are employed appropriately as the bonding method. In the case where the inlet substrate 81 is sequentially formed in a strip-shaped form, the inlet substrate 81 is separated into an independent ID chip by a substrate separating means 78. Then, a periphery of each inlet substrate 81 is processed into laminate by a laminating processing apparatus 79. At this time, a periphery of the thin film integrated circuit portion 69 is preferably covered with a filling layer 83 in advance. A filler may be mixed in the filling layer. Further, a filler may be filled in a laminate resin layer 85 in advance. The filling layer can be skipped appropriately.

In this manner, the ID chip 100 is completed. After forming a thin film integrated circuit portion 69 in a desired position of the strip-shaped substrate and performing a laminating process, the substrate may be isolated into an independent ID chip. The ID chip 100 that has been subjected to the laminate processing is collected by a collecting means 80.

Note that the coating means of the thin film integrated circuit portion 69 is not limited to a laminating method. In addition, various materials such as a piece of paper or a resin can appropriately be employed as a material for coating. For example, a flexible resin material such as plastic having flexibility is used and thus the ID chip 100 can be treated easily.

FIG. 8B is a cross-sectional and magnified view of the ID chip 100 manufactured according to this embodiment. The antenna 82 and the thin film integrated circuit portion 69 connected to the antenna 82 are formed on the inlet substrate 81, and the inlet substrate 81 is covered with the laminate resin layer 85 with the filling layer 83 interposed therebetween. The antenna 82 may be directly connected to the thin film integrated circuit portion 69 or a connection pad portion including a conductive material may be formed between the antenna 82 and the thin film integrated circuit portion 69.

In order to protect the thin film integrated circuit portion 69 and the antenna 82 in a heat treatment or the like during the laminating process, it is desirable to use a heat-resistant organic resin such as siloxane for the filling layer 83. In addition, a protective film may be formed separately. A film including carbon such as DLC or carbon nitride (CN), a silicon nitride film, a silicon nitride oxide film, or the like can be used a the protective film. However, the protective film is not limited thereto. A method such as a plasma CVD method or an atmospheric plasma method can be used as a forming method thereof.

In this embodiment, a method may be employed as a method for peeling the substrate, in which stress is given to the substrate provided with a plurality of thin film integrated circuit portions to peel the substrate physically. In this case, materials such as W, SiO₂, and WO₃ can be used as the peeling layer. In order to give stress, shock is preferably applied with a diamond pen or the like.

Alternatively, the substrate can ultimately be separated due to physical peeling by etching the peeling layer 41 partway using ClF₃ or the like as the peeling method. In addition to the foregoing method, sealing by a laminating process may be performed as the physical peeling method by transferring the thin film integrated circuit portion 69 to the laminate resin layer with an adhesive agent or the like and further covering the thin film integrated circuit portion 69 by another laminate resin layer.

In this embodiment, after forming the thin film integrated circuit portion 69, the thin film integrated circuit portion 69 is attached to the inlet substrate 81 where the antenna 82 is formed in advance so that the thin film integrated circuit portion 69 is connected to the antenna 82. However, the antenna 82 can be incorporated in manufacturing the thin film integrated circuit portion 69. In this case, the antenna 82 may be formed directly in the connection wiring 67 or the connection wiring 67 and the antenna 82 can be integrated using the same material.

In this case, it is not necessary to prepare the inlet substrate 81 particularly, and a periphery of the completed thin film integrated circuit portion 69 can be directly coated with the laminate resin layer 85 or the like. Thus, a structure and a manufacturing step of the ID chip 100 can be simplified to a large extent.

In addition, coating may be performed using the foregoing protective film without forming the laminate resin layer 85. The protective film for coating can be formed while manufacturing the thin film integrated circuit portion 69 after forming the antenna.

The ID chip 100 formed according to the foregoing method is used to make a piece of paper or mixed into a film resin; therefore, the ID chip 100 is mounted on a medium such as a piece of paper or a film. Alternatively, the ID chip 100 may be sandwiched between mediums such as a piece of paper or a film.

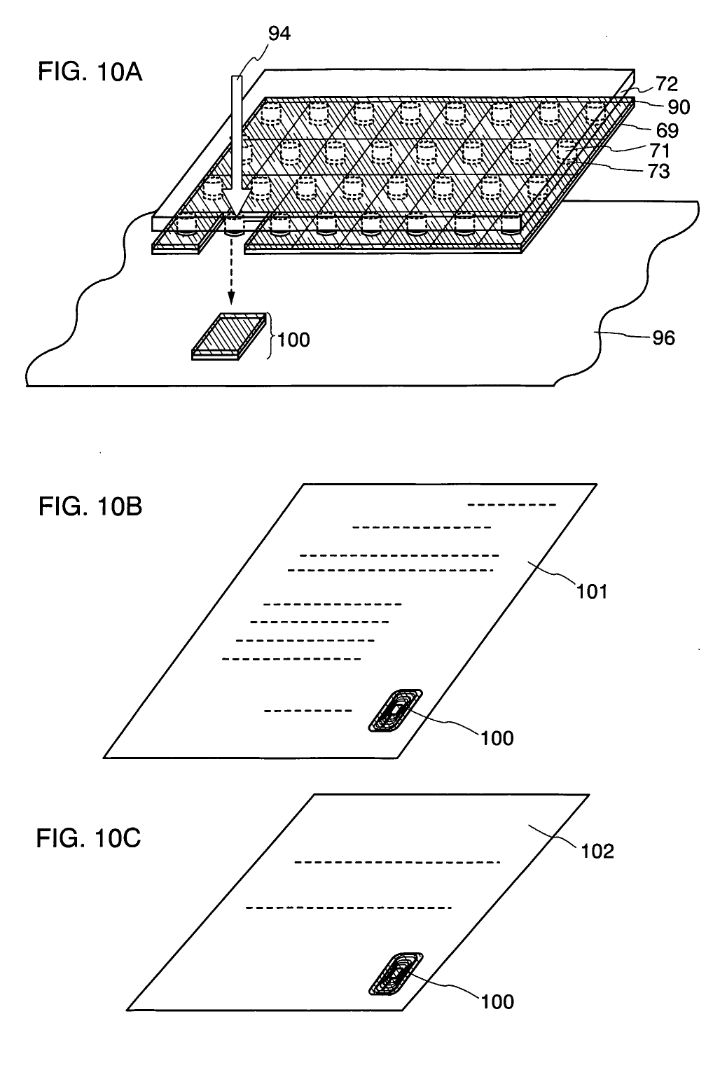

In this manner, a piece of paper installed with an ID chip is completed. FIG. 10B illustrates an external view of a piece of paper installed with an ID chip 101 according to the invention. Individual recorded information is embedded in the piece of paper installed with an ID chip 101 by print, script, or the like. However, the information embedded in the ID chip for controlling whether copying or the like of the recorded information can be performed or not is stored before or after the print by an R/W.

Right after the completion of the piece of paper installed with an ID chip 101, the information may be stored by the R/W. In this case, the piece of paper installed with an ID chip 101 serves as a piece of paper installed with an ID chip 101 having either characteristic that copy is available or not as long as the information is not rewritten.

In the case of a book or the like, the ID chip 100 may be mounted on a cover of the book or the like.

Note that this embodiment can be arbitrarily combined with the other embodiment modes and embodiments.

### Embodiment 2

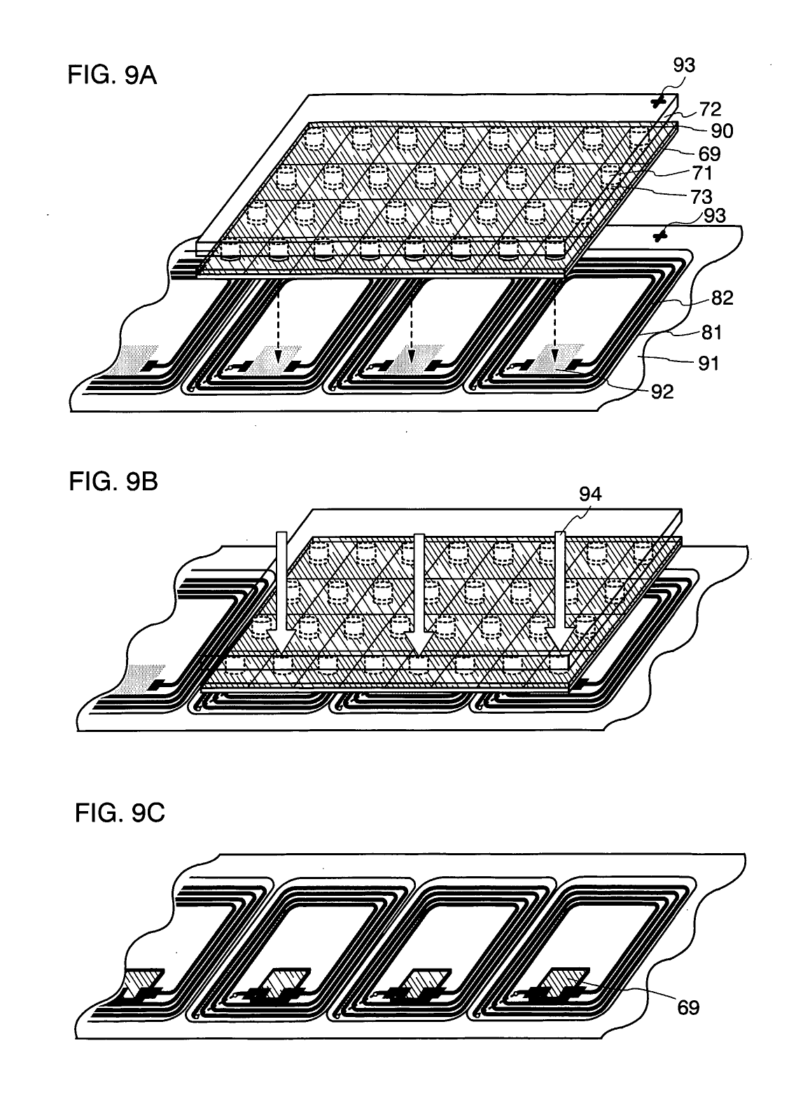

This embodiment describes a method for directly transferring and attaching a thin film integrated circuit portion 69 to an inlet substrate 81 for forming an ID chip without removing a jig 72 attached to the thin film integrated circuit portion 69 after separating the thin film integrated circuit portion 69 by a halogen fluoride gas according to Embodiment 1 with reference to FIGS. 9A to 9C.

First, as in Embodiment 1, a plurality of thin film integrated circuit portions 69 is formed and the jig 72 is attached by an adhesive agent 73 interposed therebetween. As illustrated in FIG. 9A, a material having a protrusion 71 is used for the jig 72. Here, a material whose adhesion is reduced or lost by UV-light irradiation is used for the adhesive agent 73, and a UV irradiation peeling tape manufactured by Nitto Denko Corp. is used. In addition, a protective film 90 formed of an organic material or an inorganic material is provided to prevent the thin film integrated circuit portions 69 from being damaged. Etching is performed by halogen fluoride such as ClF₃ to isolate elements from each other.

Next, the jig 72 attached with the plurality of thin film integrated circuit portions 69 is transferred and aligned with a stage 91 in which the inlet substrates 81 of ID chips are arranged. At this time, as illustrated in FIG. 9A, an alignment marker 93 provided for the jig 72 and the stage 91 can be used. An adhesive agent 92 has been formed in advance in a portion of the inlet substrate 81 for forming the thin film integrated circuit portion 69, and a desired element is attached to a desired portion of the inlet substrate 81 by controlling the position of the jig 72 (FIG. 9A). Simultaneously, the thin film integrated circuit portion 69 is electrically connected to an antenna 82 formed on the inlet substrate 81.

The thin film integrated circuit portion 69 desired to be attached to the inlet substrate 81 is selectively irradiated with UV light 94, with a mask or directly without a mask, to reduce or cause a loss of adhesion of the adhesive agent 73, thereby separating the jig 72 from the thin film integrated circuit portion 69 (FIG. 9B). Thus, the desired thin film integrated circuit portion 69 can be formed in a desired portion of the inlet substrate 81 (FIG. 9C). Here, although the antenna 82 is formed inside of the inlet substrate 81, an antenna may be formed in advance in the thin film integrated circuit portion 69.

According to the invention described in this embodiment, the desired thin film integrated circuit portion 69 can be formed in a desired portion, without separating elements discretely, when the elements are separated from each other by etching using halogen fluoride such as ClF₃.

Note that this embodiment can be arbitrarily combined with the other embodiment modes and embodiments.

### Embodiment 3

This embodiment describes a method for manufacturing another piece of paper installed with an ID chip 101 or the like with reference to FIGS. 10A to 10C. After manufacturing an ID chip 100 and separating a thin film integrated portion 69 according to Embodiment 1, the ID chip 100 is directly attached to a mounted place of a piece of paper and a film by UV light irradiation. This method is employed as a method according to this embodiment. Here, an ID chip including a thin film integrated portion where an antenna is formed in advance may also be used as the ID chip. If required, a protective film may be formed in a periphery of the thin film integrated portion as in FIG. 10A.

Each reference numeral in FIGS. 10A to 10C corresponds to that in Embodiment 2. In addition, reference numeral 96 denotes a substance (hereinafter just referred to as a “raw material”) that is used as a raw material of a piece of paper, a film, or the like.

Here, a material whose adhesion is reduced or lost by irradiation of UV-light 94 is used for an adhesive agent 73, and an UV irradiation peeling tape manufactured by Nitto Denko Corp. is used. After separating the thin film integrated circuit portion 69 where an antenna is formed, a jig 72 attached to the plurality of thin film integrated circuit portions 69 is transferred.

The thin film integrated circuit portion 69 to be attached to the inlet substrate 81 is selectively irradiated with UV light 94, with a mask or directly without a mask, to reduce or cause a loss of adhesion of the adhesive agent 73, thereby separating the jig 72 from the thin film integrated circuit portion 69. Thus, a desired ID chip 100 can be formed (dropped) in a desired portion of the raw material 96.

At the same time, the number of the ID chips to be dropped is not limited that illustrated in the drawing, and the ID chip 100 can be dropped at intervals or at random in a single number or a plurality of numbers by adjusting the irradiation region of the UV light 94.

After attaching the ID chip 100 in the raw material 96, a medium such as the piece of paper installed with an ID chip 101 or a film installed with an ID chip 102 is completed by means such as for solidifying the raw material 96. FIG. 10B illustrates an external view of the piece of paper installed with an ID chip 101, and FIG. 10C illustrates an external view of the film installed with an ID chip 102.

According to the present invention described in this embodiment, the desired ID chip 100 can be formed in a desired portion of the piece of paper installed with an ID chip 101 or the like, without separating elements discretely, when the elements are separated by etching using halogen fluoride such as ClF₃.

Note that this embodiment can be arbitrarily combined with the other embodiment modes and embodiments.

### Embodiment 4

A copy machine or the like according to the present invention is convenient in managing a copy of a copyrighted work of a book or the like at a public institution such as a library.

For example, a semiconductor device 4 manufactured according to the invention is mounted on a so-called book for reference only or the like, and information on forbidding a copy is inputted into the semiconductor device. In the case of copying using a copy machine or the like according to the invention, the information on the semiconductor device 4 is read from an R/W 2 mounted on the copy machine or the like; thus, a copy can be forbidden certainly.

Even in the case of a book or the like that is excluded from a book only for reference, the use frequency (the number of times copied) of a book or the like by pubic can be grasped by writing the number of times copying the book or the like in the semiconductor device 4 (see FIG. 12).

In getting a membership card at a rental video shop or the like, sometimes it is required to present or copy an identification card such as a driving license or a student identification card. Even when the identification card is copied, if a copy machine according to the invention is used in such a situation and a semiconductor device is mounted on the copy material, information on forbidding subsequent copies can be inputted from an R/W mounted on the copy machine (see FIG. 12) and thus personal information can be protected appropriately.

### INDUSTRIAL APPLICABILITY

As described in a foregoing manner, a copy machine, a scanner, and a facsimile; and a piece of paper and a film each installed with a semiconductor device capable of controlling whether copying can be performed or not by using the copy machine, the scanner, and the facsimile can be used in various situations of everyday life and economic activities. Thus, the utilization scope of the invention is extremely broad.

1. A copy machine including a copy control function comprising:
a reader capable of communicating with a semiconductor device mounted on a manuscript;
a control portion for controlling whether the manuscript can be copied or not based on an information obtained from the reader; and
an optical system and a print unit.

2. A copy machine including a copy control function comprising:
a reader capable of communicating with a semiconductor device mounted on a manuscript;
a control portion for controlling whether the manuscript can be copied or not based on an information obtained from the reader; and
an optical system, a light-receiving element, an image processing portion, a laser scanner, and a print unit.

3. The copy machine including the copy control function according to claim 1 or 2, wherein the reader comprises a function to write an information into the semiconductor device mounted on the manuscript or into a semiconductor device mounted on a copied material.

4. A piece of paper installed with a semiconductor device capable of controlling whether copying can be performed or not by the copy machine including the copy control function according to claim 1 or 2.

5. The piece of paper installed with the semiconductor device according to claim 4, wherein the semiconductor device comprises a thin film integrated circuit portion including a thin film transistor.

6. A film installed with a semiconductor device capable of controlling whether copying can be performed or not by the copy machine including the copy control function according to claim 1 or 2.

7. The film installed with the semiconductor device according to claim 6, wherein the semiconductor device comprises a thin film integrated circuit portion including a thin film transistor.

8. A scanner including a scan control function comprising:
a reader capable of communicating with a semiconductor device mounted on a manuscript;
a control portion for controlling whether the manuscript can be scanned or not based on an information obtained from the reader; and
an optical system, a light-receiving element, and an image processing portion.

9. The scanner including the scan control function according to claim 8, wherein the reader comprises a function to write an information into the semiconductor device mounted on the manuscript.

10. A facsimile including a read control function comprising:
a reader capable of communicating with a semiconductor device mounted on a manuscript;
a control portion for controlling whether the manuscript can be read or not based on an information obtained from the reader;
an optical system, a light-receiving element, and an image processing portion; and
a communication control portion for transmitting an information which is read.

11. The facsimile including the read control function according to claim 10, wherein the reader comprises a function to write an information into the semiconductor device mounted on the manuscript.
